(19) United States
(12) Patent Application Publication
(10) Pub. No.: US 2026/0219597 A1
(43) Pub. Date: Jul. 30, 2026

(54) IMAGE FORMING APPARATUS

(71) Applicant: CANON KABUSHIKI KAISHA, Tokyo (JP)

(72) Inventors: MANATO KOBAYASHI, Chiba (JP); YUSUKE MINATO, Ibaraki (JP)

(21) Appl. No.: 19/457,628

(22) Filed: Jan. 23, 2026

(30) Foreign Application Priority Data
Jan. 25, 2025 (JP) 2025-011012

(51) Int. Cl. G03G 15/01; G03G 15/00

(52) U.S. Cl. CPC G03G 15/0131; G03G 15/0189; G03G 15/50; G03G 15/55; G03G 15/80

(57) ABSTRACT

An image forming apparatus includes first and second photosensitive members, an intermediary transfer belt, first and second primary transfer members, first and second electrode members, first and second applying portions, a third applying portion as a common power source, first to third detecting portions, and a controller. In an operation in a setting mode, the controller sets (i) a transfer bias applied to the first primary transfer member, on the basis of a first detection result of the third detecting portion when a bias is applied to the first primary transfer member without applying a bias to the second primary transfer member, and (ii) a transfer bias applied to the second primary transfer member, on the basis of a second detection result of the third detecting portion when the bias is applied to the second primary transfer member without applying the bias to the first primary transfer member.

### BACKGROUND

### Field of the Technology

The present disclosure relates to an image forming apparatus such as a copying machine, a printer, a facsimile machine, or a multi-function machine having a plurality of functions of these machines, a printer, a facsimile machine, of an electrophotographic type or an electrostatic recording type.

### Description of the Art

As an image forming apparatus, such as a color copying machine, a color printer, or a color multi-function machine, of the electrophotographic type, an image forming apparatus employing an intermediary transfer type has become mainstream since the image forming apparatus has advantages such that downsizing of an apparatus main assembly and adaptation to various recording materials are relatively easy. The image forming apparatus of the intermediary transfer type is constituted by including, in general, a plurality of photosensitive drums and an intermediary transfer belt.

In such an image forming apparatus, toner images formed on the photosensitive drums are electrostatically primary-transferred successively onto the intermediary transfer belt in primary transfer portions. Further, the toner images primary-transferred on the intermediary transfer belt are electrostatically secondary-transferred onto a recording material such as paper in a secondary transfer portion. Incidentally, as regards arrangement of members around the primary transfer portion and the like, "upstream" and "downstream" refer to "upstream" and "downstream", respectively, with respect to a conveying direction of the intermediary transfer belt unless otherwise specified.

The toner on the intermediary transfer belt has a tendency that on a side downstream of the primary transfer portion, the toner is subjected to electric discharge between the intermediary transfer belt and the photosensitive drum and is increased in charge amount. Then, when the present inventor has proceeded with study, it turned out that the toner on the intermediary transfer belt is increased in charge amount and thus it become difficult to transfer the toner onto the recording material in the secondary transfer portion. For example, a secondary transfer electric field necessary to transfer the toner onto the recording material in the secondary transfer portion becomes large, so that graininess of an image becomes worse or uniform transfer of the toner onto embossed paper with surface unevenness becomes difficult.

In Japanese Laid-Open Patent Application (JP-A) 2024-120797, a constitution in which a potential regulating member which is an electroconductive electrode member is provided on a state downstream of the primary transfer portion and on an inner peripheral surface side of the intermediary transfer belt and in which a bias of the same polarity as a charge polarity of the photosensitive drum is applied to this potential regulating member has been proposed. In addition, in the constitution described in JP-A 2024-120797, correction of a primary transfer bias in view of a current flowing from the primary transfer portion to the potential regulating member is made in order not to impair a primary transfer property by the current flowing from the primary transfer portion to the potential regulating member.

In order to suppress an increase in charge amount of the toner due to the electric discharge on the side downstream of the primary transfer portion, it is effective that the bias of the same polarity as the charge polarity of the photosensitive drum is applied to the potential regulating member disposed on the side downstream of the primary transfer portion and on the inner peripheral surface side of the intermediary transfer belt.

Here, in order to suppress increases in cost and size of an apparatus main assembly of the image forming apparatus, it is desired that the number of high-voltage power sources (high-voltage substrates) for applying biases to potential regulating members is made small. For that reason, it would be considered that an image forming apparatus employs a constitution in which a bias is applied from a common high-voltage power source to a plurality of potential regulating members provided for a plurality of primary transfer portions, respectively. That is, it would be considered that the plurality of potential regulating members provided in the image forming apparatus are connected in parallel to a single high-power source or high-voltage power sources in the number smaller than the number of the potential regulating members.

However, for example, arrangement tolerances of the primary transfer portions and the potential regulating members, a fluctuation of impedance of the primary transfer portions, and the like are different for each of the primary transfer portions, so that a current flowing from the primary transfer portion to the associated potential regulating member is different for each of the plurality of primary transfer portions in some instances. For that reason, an appropriate correction amount of a primary transfer bias is different for each of the plurality of primary transfer portions in some instances.

In JP-A 2014-120797, correction control of the primary transfer bias for a single primary transfer portion is mentioned, but correction control in the case where the number of the high-voltage power sources for applying biases to the plurality of the potential regulating members is made one or the number smaller than the number of the plurality of potential regulating members is not considered.

### SUMMARY

Therefore, the present disclosure is directed to improve a secondary transfer property while maintaining a primary transfer property in each of a plurality of primary transfer portions in a constitution in which a bias is applied from a power source common to a plurality of electrode members provided for the plurality of primary transfer portions, respectively.

This is achieved by an image forming apparatus according to the present disclosure.

According to an aspect of the present disclosure, there is provided an image forming apparatus comprising: a first photosensitive member capable of being charged to a predetermined polarity and confirmed to carry a toner image; a second photosensitive member capable of being charged to the predetermined polarity and confirmed to carry a toner image; an intermediary transfer belt configured to convey a toner image primarily transferred from the first photosensitive member in a first primary transfer portion contacting the first photosensitive member and a toner image primarily transferred from the second photosensitive member in a second primary transfer portion contacting the second photosensitive member so as to secondarily transfer these toner images onto a recording material in a secondary transfer portion, and capable of being circulated and moved; a first primary transfer member configured to form the first primary transfer portion in contact with an inner peripheral surface of the intermediary transfer belt; a second primary transfer member configured to form the second primary transfer portion in contact with the inner peripheral surface of the intermediary transfer belt; a first electrode member provided on a side downstream of the first primary transfer portion with respect to a movement direction of the intermediary transfer belt and contacting the inner peripheral surface of the intermediary transfer belt; a second electrode member provided on a side downstream of the second primary transfer portion with respect to the movement direction of the intermediary transfer belt and contacting the inner peripheral surface of the intermediary transfer belt; a first applying portion configured to apply a bias of an opposite polarity to the predetermined polarity to the first primary transfer member; a second applying portion configured to apply a bias of the opposite polarity to the predetermined polarity to the second primary transfer member; a third applying portion as a common power source configured to apply a bias of the same polarity as the predetermined polarity to the first electrode member and the second electrode member; a first detecting portion configured to detect a current flowing through the first applying portion or a voltage applied to the first applying portion; a second detecting portion configured to detect a current flowing through the second applying portion or a voltage applied to the second applying portion; a third detecting portion configured to detect a current flowing through the third applying portion or a voltage applied to the third applying portion; and a controller configured to be capable of executing an operation in a setting mode during non-image formation in which the controller sets a transfer bias applied to the first primary transfer member, on the basis of a detection result of the first detecting portion when a first test bias is applied to the first primary transfer member, and the controller sets a transfer bias applied to the second primary transfer member, on the basis of a detection result of the second detecting portion when a second test bias is applied to the second primary transfer member, wherein in the operation in the setting mode, the controller sets (i) the transfer bias applied to the first primary transfer member, on the basis of a first detection result of the third detecting portion when the bias is applied to the first primary transfer member by the first applying portion without applying the bias to the second primary transfer member by the second applying portion, and (ii) the transfer bias applied to the second primary transfer member, on the basis of a second detection result of the third detecting portion when the bias is applied to the second primary transfer member by the second applying portion without applying the bias to the first primary transfer member by the first applying portion.

According to another aspect of the present disclosure, there is provided an image forming apparatus comprising: a first photosensitive member capable of being charged to a predetermined polarity and confirmed to carry a toner image; a second photosensitive member capable of being charged to the predetermined polarity and confirmed to carry a toner image; an intermediary transfer belt configured to convey a toner image primarily transferred from the first photosensitive member in a first primary transfer portion contacting the first photosensitive member and a toner image primarily transferred from the second photosensitive member in a second primary transfer portion contacting the second photosensitive member so as to secondarily transfer these toner images onto a recording material in a secondary transfer portion, and capable of being circulated and moved; a first primary transfer member configured to form the first primary transfer portion in contact with an inner peripheral surface of the intermediary transfer belt; a second primary transfer member configured to form the second primary transfer portion in contact with the inner peripheral surface of the intermediary transfer belt; a first electrode member provided on a side downstream of the first primary transfer portion with respect to a movement direction of the intermediary transfer belt and contacting the inner peripheral surface of the intermediary transfer belt; a second electrode member provided on a side downstream of the second primary transfer portion with respect to the movement direction of the intermediary transfer belt and contacting the inner peripheral surface of the intermediary transfer belt; a first applying portion configured to apply a bias of an opposite polarity to the predetermined polarity to the first primary transfer member; a second applying portion configured to apply a bias of the opposite polarity to the predetermined polarity to the second primary transfer member; a third applying portion as a common power source configured to apply a bias of the same polarity as the predetermined polarity to the first electrode member and the second electrode member; a first detecting portion configured to detect a current flowing through the first applying portion or a voltage applied to the first applying portion; a second detecting portion configured to detect a current flowing through the second applying portion or a voltage applied to the second applying portion; a third detecting portion configured to detect a current flowing through the third applying portion or a voltage applied to the third applying portion; and a controller configured to be capable of executing an operation in a setting mode during non-image formation in which the controller sets a transfer bias applied to the first primary transfer member and a transfer bias applied to the second primary transfer member, wherein in the operation in the setting mode, the controller sets (i) the transfer bias applied to the first primary transfer member, on the basis of a first detection result of the first detecting portion when the bias is applied to the first primary transfer member by the first applying portion in a state in which the bias is not applied to the first and second electrode members by the third applying portion, and a second detection result of the first detecting portion when the bias is applied to the first primary transfer member by the first applying portion without applying the bias to the second primary transfer member by the second applying portion in a state in which the bias is applied to the first and second electrode members by the third applying portion, and (ii) the transfer bias applied to the second primary transfer member, on the basis of a third detection result of the second detecting portion when the bias is applied to the second primary transfer member by the second applying portion in a state in which the bias is not applied to the first and second electrode members by the third applying portion, and a fourth detection result of the second detecting portion when the bias is applied to the second primary transfer member by the second applying portion without applying the bias to the first primary transfer member by the first applying portion in a state in which the bias is applied to the first and second electrode members by the third applying portion.

According to a further aspect of the present disclosure, there is provided an image forming apparatus comprising: a first photosensitive member capable of being charged to a predetermined polarity and confirmed to carry a toner image; a second photosensitive member capable of being charged to the predetermined polarity and confirmed to carry a toner image; an intermediary transfer belt configured to convey a toner image primarily transferred from the first photosensitive member in a first primary transfer portion contacting the first photosensitive member and a toner image primarily transferred from the second photosensitive member in a second primary transfer portion contacting the second photosensitive member so as to secondarily transfer these toner images onto a recording material in a secondary transfer portion, and capable of being circulated and moved; a first primary transfer member configured to form the first primary transfer portion in contact with an inner peripheral surface of the intermediary transfer belt; a second primary transfer member configured to form the second primary transfer portion in contact with the inner peripheral surface of the intermediary transfer belt; a first electrode member provided on a side downstream of the first primary transfer portion with respect to a movement direction of the intermediary transfer belt and contacting the inner peripheral surface of the intermediary transfer belt; a second electrode member provided on a side downstream of the second primary transfer portion with respect to the movement direction of the intermediary transfer belt and contacting the inner peripheral surface of the intermediary transfer belt; a first applying portion configured to apply a bias of an opposite polarity to the predetermined polarity to the first primary transfer member; a second applying portion configured to apply a bias of the opposite polarity to the predetermined polarity to the second primary transfer member; a third applying portion as a common power source configured to apply a bias of the same polarity as the predetermined polarity to the first electrode member and the second electrode member; a first detecting portion configured to detect a current flowing through the first applying portion or a voltage applied to the first applying portion; a second detecting portion configured to detect a current flowing through the second applying portion or a voltage applied to the second applying portion; a third detecting portion configured to detect a current flowing through the third applying portion or a voltage applied to the third applying portion; and a controller configured to be capable of executing an operation in a setting mode during non-image formation in which the controller sets a transfer bias applied to the first primary transfer member, on the basis of a detection result of the first detecting portion when a first test bias is applied to the first primary transfer member, and the controller sets a transfer bias applied to the second primary transfer member, on the basis of a detection result of the second detecting portion when a second test bias is applied to the second primary transfer member, wherein in the operation in the setting mode, the controller sets (i) the transfer bias applied to the first primary transfer member, on the basis of information on the current flowing through the third applying portion or the voltage applied to the third applying portion when the bias is applied to the first primary transfer member by the first applying portion without applying the bias to the second primary transfer member by the second applying portion, and (ii) the transfer bias applied to the second primary transfer member, on the basis of information on the current flowing through the third applying portion or the voltage applied to the third applying portion when the bias is applied to the first primary transfer member by the first applying portion without applying the bias to the second primary transfer member by the second applying portion.

Further features of the present invention will become apparent from the following description of exemplary embodiments with reference to the attached drawings.

### BRIEF DESCRIPTION OF THE DRAWINGS

FIG. 1 is a schematic sectional view of an image forming apparatus.

FIG. 2 is a schematic block diagram showing a control system of the image forming apparatus.

Parts (a) and (b) of FIG. 3 are a sectional view and a perspective view, respectively, of a potential regulating member.

FIG. 4 is a sectional view of another example of the potential regulating member.

FIG. 5 is a sectional view of another example of the potential regulating member.

FIG. 6 is a sectional view for illustrating an arrangement of the potential regulating member.

Parts (a) and (b) of FIG. 7 are schematic graphs for illustrating ATVC and correction of the primary transfer bias for a single primary transfer portion.

FIG. 8 is a schematic view for illustrating a current path around the primary transfer portion.

FIG. 9 is a timing chart for illustrating correction control of a primary transfer bias for the single primary transfer portion.

FIG. 10 is a flowchart for illustrating the correction control of the primary transfer bias for the single primary transfer portion.

FIG. 11 is a schematic view for illustrating a bias applying constitution for a plurality of potential regulating members.

FIG. 12 is a timing chart for illustrating correction control of primary transfer biases for a plurality of primary transfer portions in an embodiment 1.

FIG. 13 is a flowchart for illustrating the correction control of the primary transfer biases for the plurality of primary transfer portions in the embodiment 1.

FIG. 14 is a timing chart for illustrating correction control of primary transfer biases for a plurality of primary transfer portions in an embodiment 2.

FIG. 15 is a flowchart for illustrating the correction control of the primary transfer biases for the plurality of primary transfer portions in the embodiment 2.

### DESCRIPTION OF THE EMBODIMENTS

In the following, an image forming apparatus according to the present disclosure will be described in more detail with reference to the drawings.

### Embodiment 1

### 1. General structure and operation of image forming apparatus

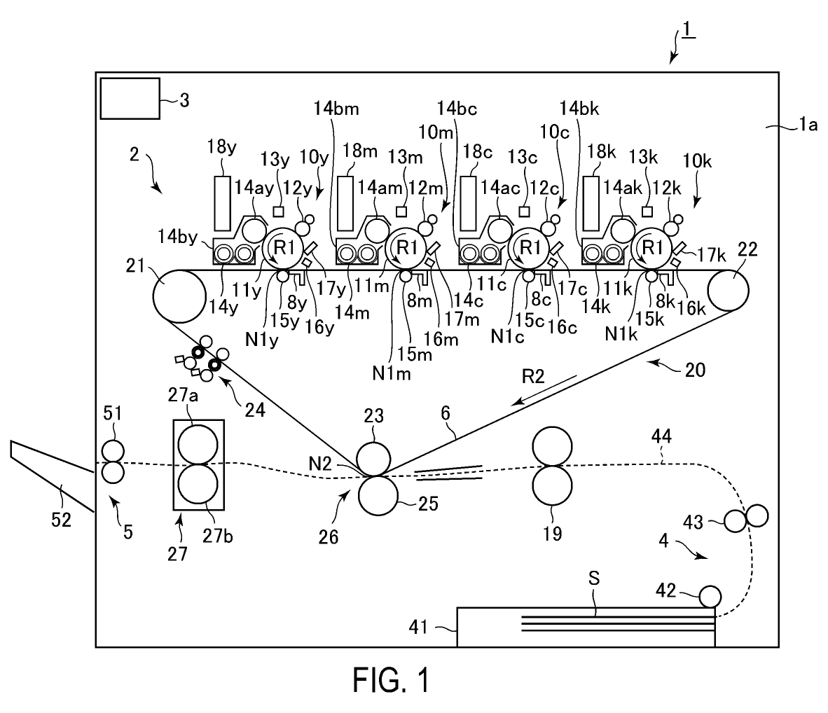

First, a general structure and an operation of the image forming apparatus of this embodiment will be described. FIG. 1 is a schematic sectional view of an image forming apparatus 1 of this embodiment. The image forming apparatus 1 of this embodiment is a tandem type full-color printer capable of forming a full-color image on a sheet-like recording material S by using an electrophotographic type system and employing an intermediary transfer type method.

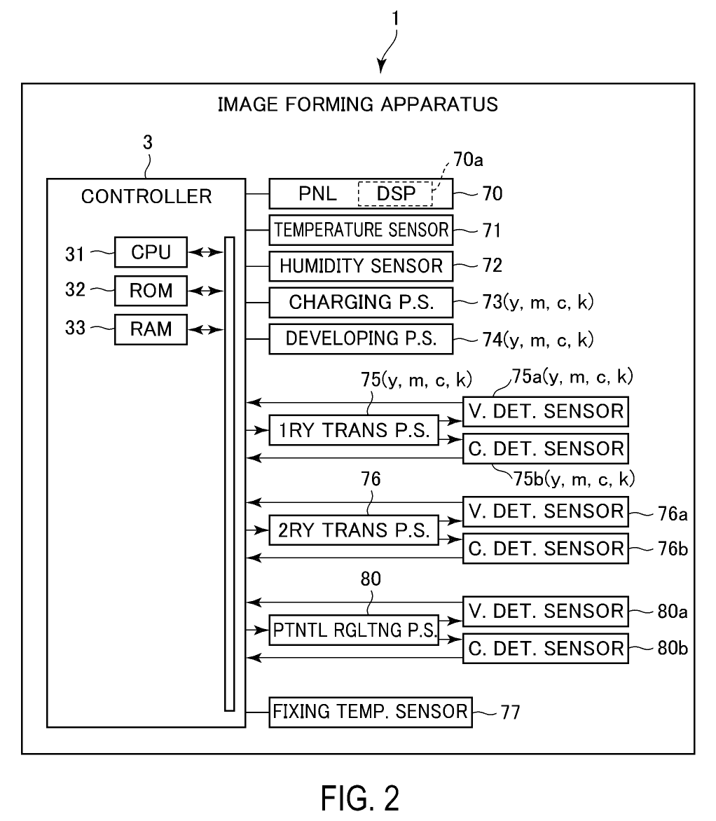

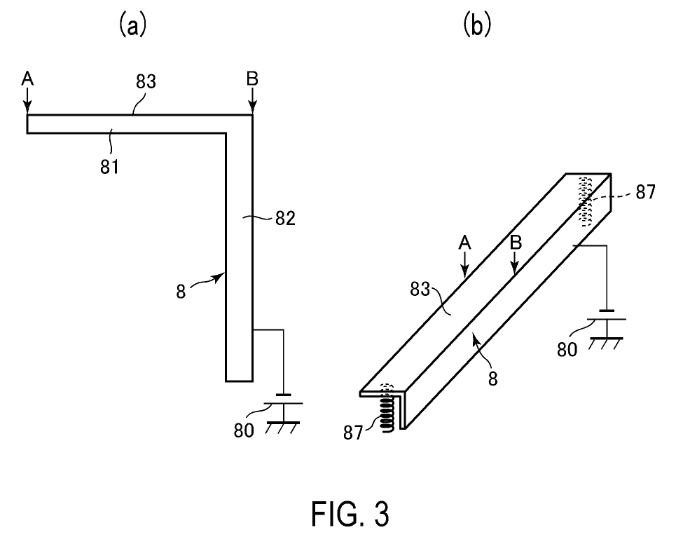

The image forming apparatus 1 includes a printer portion (engine) 2, a controller 3, a feeding portion 4 of the recording material S, and a discharging portion 5 of the recording material S. Further, inside the image forming apparatus 1, a temperature sensor 71 (FIG. 2) capable of detecting a temperature inside the apparatus and a humidity sensor 72 (FIG. 2) capable of detecting a humidity inside the apparatus are provided. The image forming apparatus 1 is capable of forming an image on the recording material S on the basis of image information (image signal) acquired by an original reading apparatus (not shown) provided on the image forming apparatus 1 or connected to the image forming apparatus 1. Further, the image forming apparatus 1 is capable of forming an image on the recording material S on the basis of image information (image signal) from an external device (not shown), such as a personal computer (host device), a digital camera, or a smartphone, connected to the image forming apparatus 1. Incidentally, the recording material (transfer material, recording medium, sheet) S is a material on which the image is formed with toner. Specific examples thereof include plain paper, thick paper, gloss coated paper, mat coated paper, embossed paper, or synthetic resin sheets (synthetic paper) which are substitutes for plain paper or the like, and overhead projector sheets (resin film). Here, the recording material S is referred to as "paper" ("paper", "embossed paper", "high-resistance paper", or the like) in some instances, but even in that case, the recording material S includes a material other than the paper or a recording material formed with a material containing the material other than the paper.

The printer portion 2 forms the image on the recording material S, fed from the feeding portion 4, on the basis of the image information. The image printer 2 includes image forming units (image forming portions) 10y, 10m, 10c, 10k, toner bottles 18y, 18m, 18c, 18k, an intermediary transfer unit 20, a secondary transfer device 26, and a fixing device 27. The image forming units 10y, 10m, 10c and 10k form toner images of colors of yellow (Y), magenta (M), cyan (C), and black (K), respectively. Elements having the same or corresponding functions of structures provided for the respective colors will be collectively described by omitting suffixes y, m, c and k for representing elements for associated colors, respectively, in some instances. Further, the image forming apparatus 1 can also form, for example, a single-color image such as a (single) black image or a multi-color image by using the image forming unit(s) 10 for a desired single color or some of the four colors.

The image forming unit 10 includes photosensitive drums 11 (11y, 11m, 11c, 11k) each being a drum-type (cylindrical) photosensitive member (electrophotographic photosensitive member) as an image bearing member. In addition, the image forming unit 10 includes charging rollers 12 (12y, 12m, 12c, 12k) each being a roller-type charging member as a charging means. In addition, the image forming unit 10 includes exposure devices 13 (13y, 13m, 13c, 13k) each as an exposure means. In addition, the image forming unit 10 includes developing devices 14 (14y, 14m, 14c, 14k) each as developing means. In addition, the image forming unit 10 includes pre-exposure devices 16 (16y, 16m, 16c, 16k) each as a discharging (charge eliminating) means. In addition, the image forming unit 10 includes a drum cleaning devices 17 (17y, 17m, 17c, 17k) each as a photosensitive member cleaning means. The image forming unit 10 forms a toner image on the photosensitive drum 11. The toner image formed on the photosensitive drum 11 is transferred onto an intermediary transfer belt 6 described hereinafter.

The photosensitive drum 11 is movable (rotatable) while carrying an electrostatic image (electrostatic latent image) or a toner image. In this embodiment, the photosensitive drum 11 is a negatively chargeable organic photosensitive member (OPC) having an outer diameter of 30 mm. The photosensitive drum 11 has an aluminum cylinder as a substrate and a surface layer formed on the surface of the substrate. In this embodiment, as the surface layer, three layers of an undercoat layer, a photocharge generation layer, and a charge transportation layer, which are applied and laminated on the substrate in the order named are provided. When an image forming operation is started, the photosensitive drum 11 is rotationally driven in a direction indicated by an arrow R1 (counterclockwise) in the figure at a predetermined peripheral speed (process speed) by a driving motor (not shown) as a driving means.

The surface of the rotating photosensitive drum 11 is uniformly electrically charged by the charging roller 12. In this embodiment, the charging roller 12 is a rubber roller which contacts the surface of the photosensitive drum 11 and which is rotated by following the rotation of the photosensitive drum 11. To the charging roller 12, charging power sources 73 (73y, 73m, 73c, 73k) (FIG. 2) each as a charging bias applying means (charging bias applying portion) is connected. The charging power source 73 applies a predetermined charging bias (charging voltage) to the charging roller 12 during the charging process.

The surface of the charged photosensitive drum 11 is scanned and exposed by the exposure device 13 on the basis of the image information, so that the electrostatic image is formed on the photosensitive drum 11. The exposure device 13 is a laser scanner in this embodiment. The exposure device 13 emits laser light in accordance with separated color image information outputted from the controller 3, and scans and exposes the surface (outer peripheral surface) of the photosensitive drum 11.

The electrostatic image formed on the photosensitive drum 11 is developed (visualized) by supplying the toner thereto by the developing device 14, so that a toner image (developer image) is formed on the photosensitive drum 11. In this embodiment, the developing device 14 is a two-component developing device using, as a developer, a two-component developer comprising toner (non-magnetic toner particles) and a carrier (magnetic carrier particles). In a developing container (developing container main body) 14b of the developing device 14, the two-component developer is accommodated, and toner in an amount corresponding to a consumed amount of the toner is supplied from the toner bottle 18. The developing device 14 includes a developing sleeve 14a as a developing member (developer carrying member). The developing sleeve 14a is made of, for example, a non-magnetic material such as aluminum or non-magnetic stainless steel (aluminum in this embodiment). Inside the developing sleeve 14a, a magnet roller (not shown) which is a roller-shaped magnet as a magnetic field-generating means (magnetic field-generating member) is fixed and arranged so as not to rotate relative to the developing container 14b. The developing sleeve 14a carries the two-component developer and conveys it to a developing region opposing the photosensitive drum 11. Then, in the developing region, the toner is moved to and deposited on an image portion of the electrostatic image on the photosensitive drum 1 from the two-component developer on the developing sleeve 14a. Developing power sources 74 (74y, 74m, 74c, 74k) (FIG. 2) as a developing bias applying means (developing bias applying portion) is connected to the developing sleeve 14a. The developing power source 74 applies a predetermined developing bias (developing voltage) to the developing sleeve 14a during the development. In this embodiment, on an exposed portion (image portion) of the photosensitive drum 11 lowered in absolute value of the potential by being exposed after being uniformly charged, the toner charged to the same polarity (negative polarity in this embodiment) as the charge polarity of the photosensitive drum 11 is deposited (reverse development type). In this embodiment, the normal charge polarity of the toner, which is a principal charge polarity of the toner during the development, is the negative polarity.

An intermediary transfer unit 20 is arranged so as to oppose the four photosensitive drums 11y, 11m, 11c and 11k. The intermediary transfer unit 20 includes the intermediary transfer belt 6 which is constituted by an endless belt as an intermediary transfer member. The intermediary transfer belt 6 is wound around, and stretched by, as a plurality of stretching rollers, a driving roller 21, a tension roller 22, and an inner secondary transfer roller 23. The intermediary transfer belt 6 is movable (rotatable) while carrying the toner image.

The driving roller 21 is rotationally driven by a driving motor (not shown) as driving means, so that a driving force is transmitted to the intermediary transfer belt 6, and thus the intermediary transfer belt 6 is rotated (circulated and moved) in an arrow R2 direction (clockwise direction) in FIG. 1 at a predetermined peripheral speed corresponding to the peripheral speed of the photosensitive drum 1. The tension roller 22 controls the tension of the intermediary transfer belt 6 to be constant. The tension roller 22 is subjected to a force which pushes the intermediary transfer belt 6 from an inner peripheral surface (back surface) side toward an outer peripheral surface (front surface) side by an urging force of a tension spring (not shown) constituted by a compression coil spring which is an urging member as an urging means. By this force, a tension of about 2 to 5 kg is applied in the conveying direction (process progression direction, movement direction) to the intermediary transfer belt 6. The inner secondary transfer roller 23 constitutes a secondary transfer device 26 in combination with an outer secondary transfer roller 25 described hereinafter. On the inner peripheral surface side of the intermediary transfer belt 6, the primary transfer rollers 15y, 15m, 15c, 15k, which are roller-type primary transfer members as primary transfer means, are provided correspondingly to the photosensitive drums 11y, 11m, 11c, 11k, respectively. In this embodiment, the primary transfer rollers 15 are disposed opposed to the photosensitive drums 11 and nip the intermediary transfer belt 6 between themselves and the photosensitive drums 11. Each of the primary transfer rollers 15 is pressed toward the photosensitive drum 11 and contacts the photosensitive drum 11 by way of the intermediary transfer belt 6, and forms a primary transfer portion (primary transfer nip) N1 which is a contact portion between the photosensitive drum 11 and the intermediary transfer belt 6. The stretching rollers other than the driving roller 21 and the primary transfer rollers 15 are rotated with the rotation of the intermediary transfer belt 6. Incidentally, the number of the stretching rollers is not limited to the number in this embodiment, but may also be the number more than the number in this embodiment.

The toner image formed on the photosensitive drum 11 is transferred (primarily transferred) onto the rotating intermediary transfer belt 6 in the primary transfer portion N1 by the action of the primary transfer roller 15. For example, when forming a full-color image, the yellow, magenta, cyan and black toner images formed on the photosensitive drums 11 are multiple-transferred so as to be sequentially superimposed on the intermediary transfer belt 6. Primary transfer power sources 75 (75y, 75m, 75c, 75k) (FIG. 2) each as a primary transfer bias applying means (primary transfer bias applying portion) is connected to the primary transfer roller 15. During the primary transfer, the primary transfer power source 75 applies a primary transfer bias (primary transfer voltage) which is a DC voltage having a polarity opposite to the normal charge polarity of the toner (positive polarity in this embodiment) to the primary transfer roller 15. By this, the toner image comprising toner of the negative polarity on the photosensitive drum 11 is primarily transferred onto the intermediary transfer belt 6.

To the primary transfer power source 75, a voltage detecting sensor 75a (FIG. 2) as a voltage detecting means (voltage detecting portion) for detecting an output voltage thereof and a current detecting sensor 75b (FIG. 2) as a current detecting means (current detecting portion) for detecting an output current thereof are connected. In this embodiment, for example, a primary transfer bias of about 1 kV to 2 kV is applied to the primary transfer roller 15 ("1 kV to 2 kV" shows a range including 1 kV and 2 kV, and the same applies hereinafter). In addition, in this embodiment, the primary transfer bias is subjected to constant-voltage control. In this embodiment, the primary transfer power sources 75y, 75m, 75c and 75k are provided independently for the primary transfer rollers 15y, 15m, 15c and 15k, respectively. Further, in this embodiment, the primary transfer biases applied to the primary transfer rollers 15y, 15m, 15c and 15k can be individually controlled.

Here, in this embodiment, the primary transfer roller 15 has a core metal and an elastic layer of ion conductive foam rubber (NBR rubber) (nitrile) formed at a periphery of the core metal. An outer diameter of the primary transfer roller 15 is, for example, 15 to 20 mm. In addition, as the primary transfer roller 15, a roller having an electric resistance value of 1x105 to 1x108 Ω (N/N (23°C, 50 %RH) condition, 2 kV applied) can be preferably used.

Further, in this embodiment, the intermediary transfer belt 6 is an endless belt having a two-layer structure including a base layer, and a surface layer in this order from the inner peripheral surface side toward the outer peripheral surface side. As the material constituting the base layer, a resin such as polyimide or polycarbonate, in which an appropriate amount of carbon black is contained as an antistatic agent can be suitably used. The thickness of the base layer is, for example, 0.05 to 0.15 mm. As a material constituting the surface layer, a resin such as chloroprene rubber (CR) to which electroconductivity is imparted by carbon black can be suitably used. The thickness of the surface layer is, for example, 0.200 to 0.300 mm. In this embodiment, the intermediary transfer belt 6 has a volume resistivity of 5x108 to 1x1014 Ω.cm (23°C, 50 %RH). Incidentally, in this embodiment, the two-layer structure was employed in the intermediary transfer belt 6, but a single-light structure of a material corresponding to the material of the above-described base layer may also be employed. Further, the surface layer may also be formed as a resin-coated layer, of about 0.002 to 0.01 mm in thickness, containing a resin material such as a fluorine-containing resin. Further, the intermediary transfer belt 6 may have a multi-layer structure of three or more layers.

On the outer peripheral surface side of the intermediary transfer belt 6, the outer secondary transfer roller 25 which is a roller-type secondary transfer member as a secondary transfer means is disposed. The outer secondary transfer roller 25 as the secondary transfer member constitutes the secondary transfer device 26 in cooperation with the inner secondary transfer roller 23 as an opposing member (opposing electrode). The outer secondary transfer roller 25 is pressed toward the inner secondary transfer roller 23, and contacts the inner secondary transfer roller 23 by way of the intermediary transfer belt 6 and forms a secondary transfer portion (secondary transfer nip) N2 which is a contact portion between the intermediary transfer belt 6 and the outer secondary transfer roller 25. The toner image formed on the intermediary transfer belt 6 is transferred (secondarily transferred) onto the recording material S, nipped and conveyed by the intermediary transfer belt 6 and the outer secondary transfer roller 25, by the action of the secondary transfer device 26 in the secondary transfer portion N2. To the outer secondary transfer roller 25, a secondary transfer power source 76 (FIG. 2) as a secondary transfer bias applying means (secondary transfer bias applying portion) is connected. During the secondary transfer, the secondary transfer power source 76 applies a secondary transfer bias (secondary transfer voltage) which is a DC voltage having a polarity (positive polarity in this embodiment) opposite to the normal charge polarity of the toner to the outer secondary transfer roller 25. By this, the toner image comprising the toner of the negative polarity on the intermediary transfer belt 6 is secondarily transferred onto the recording material S. To the secondary transfer power source 76, a voltage detecting sensor 76a (FIG. 2) as a voltage detecting means (voltage detecting portion) for detecting the output voltage thereof and a current detecting sensor 76b (FIG. 2) as a current detecting means (current detecting portion) for detecting the output current thereof are connected. Further, the core metal of the inner secondary transfer roller 23 is connected to the ground potential (electrically grounded). In this embodiment, for example, a secondary transfer voltage of about 1 to 6.5 kV is applied to the secondary transfer roller 25, and a current of about 15 to 100 μA is caused to flow through the secondary transfer portion N2, so that the toner image on the intermediary transfer belt 6 is secondarily transferred onto the recording material S. In this embodiment, during the secondary transfer, the secondary transfer bias is subjected to constant-voltage control. Incidentally, a constitution in which to the inner secondary transfer roller 23 as the secondary transfer member, the secondary transfer bias which is the DC voltage of the same polarity as the normal charge polarity of the toner is applied from the secondary transfer power source 76, so that the outer secondary transfer roller 25 as the opposing member is connected to the ground potential may also be employed.

The recording material S is fed from the feeding portion 4 toward the secondary transfer portion N2 in parallel to the forming operation of the toner image onto the intermediary transfer belt 6. The recording material S is accommodated in a cassette 41 as a recording material accommodating portion of the feeding portion 4. The recording material S accommodated in the cassette 41 is separated and fed one by one from the cassette 41 by a feeding roller 42 or the like as a feeding member of the feeding portion 4. This recording material S is conveyed by a conveying roller 43 or the like as a conveying member of the feeding portion 4 to a registration roller pair 19 as a conveying member provided on a conveying passage 44 of the recording material S. Then, this recording material S is conveyed by the registration roller pair 19 to the secondary transfer portion N2 by being timed to the toner image on the intermediary transfer belt 6. Incidentally, in FIG. 1, only one cassette 41 is illustrated, but the image forming apparatus 1 may also include a plurality of cassettes 41. Further, the feeding portion 4 may be capable of feeding the recording material S also from a recording material accommodating portion (recording material mounting portion), other than the cassette 41, such as a manual feeding tray or the like.

Here, in this embodiment, the outer secondary transfer roller 25 includes a core metal and an elastic layer of ion conductive foam rubber (NBR rubber) formed around the core metal. The outer diameter of the outer secondary transfer roller 25 is, for example, 20 to 25 mm. In addition, as the outer secondary transfer roller 25, a roller having an electric resistance value of 1x105 to 1x108 Ω (measured at N/N (23°C, 50 %RH), 2 kV applied) can be preferably used.

The recording material S onto which the toner image has been transferred is fed to the fixing device 27 as a fixing means. The fixing device 27 includes a fixing roller 27a and a pressing roller 27b. The fixing roller 27a includes therein a heater as a heating means. The pressing roller 27b is press-contacted to the fixing roller 27a and forms a fixing portion (fixing nip). The fixing device 27 causes the recording material S carrying the unfixed toner image to be heated and pressed by nipping and conveying the recording material S between the fixing roller 27a and the pressing roller 27b, and thus causes the toner image to be fixed (melted, sticked) on the recording material S. Incidentally, the temperature of the fixing roller 27a (fixing temperature) is detected by a fixing temperature sensor 77 (FIG. 2). The recording material S on which the toner image is fixed is conveyed in the discharging portion 5 by a discharging roller pair 51 or the like, and is discharged (outputted) through a discharge opening (not shown), onto a discharge tray 52 provided outside an apparatus main assembly 1a of the image forming apparatus 1.

The surface of the photosensitive drum 11 after the primary transfer is electrically discharged by the pre-exposure device 16. In addition, toner remaining on the photosensitive drum 11 without being transferred onto the intermediary transfer belt 6 during the primary transfer (primary transfer residual toner) is removed from the surface of the photosensitive drum 11 by the drum cleaning device 17 and is collected. In this embodiment, the drum cleaning device 17 scrapes off the primary transfer residual toner from the surface of the rotating photosensitive drum 11 by a cleaning blade as a cleaning member, and collects the primary transfer residual toner in a collecting container (not shown). The cleaning blade is a plate-like member contacting the photosensitive drum 11 with a predetermined pressing force. The cleaning blade contacts the surface of the photosensitive drum 11 in a counter direction to the rotational direction of the photosensitive drum 11 so that a leading end thereof on a free end portion side faces the upstream side of the rotational direction of the photosensitive drum 11. Further, a deposited matter such as toner remaining on the intermediary transfer belt 6 without being transferred onto the recording material S during the secondary transfer (secondary transfer residual toner) or the like is removed and collected from the surface of the intermediary transfer belt 6 by a belt cleaning device 24 as an intermediary transfer member cleaning means.

Incidentally, in each of the image forming units 10, for example, the photosensitive drum 11, the charging roller 12, the developing device 14, the pre-exposure device 16 and the drum cleaning device 17 may integrally constitute a cartridge (process cartridge) integrally detachably mountable to the apparatus main assembly 1a. In this embodiment, the intermediary transfer unit 20 is constituted by the intermediary transfer belt 6, the stretching rollers for the intermediary transfer belt 6, the respective primary transfer rollers 15, the belt cleaning device 24, and potential regulating members 8 and the like described hereinafter. The intermediary transfer unit 20 may be integrally detachably mountable to the apparatus main assembly 1a.

### 2. Control constitution

FIG. 2 is a block diagram showing a schematic constitution of a control system of the image forming apparatus 1 of this embodiment. The image forming apparatus 1 is provided with the controller (control circuit) 3 as a control means. The controller 3 is constituted by including a CPU 31 as a calculating means (calculating portion), a ROM 32 and a RAM 33 each as a storing means (storing portion), and an input/output circuit (I/F) (not shown) for inputting/outputting signals between itself and the external device. The ROM 32 stores programs or the like for controlling the respective portions of the image forming apparatus 1. The RAM 33 temporarily stores data on the control. The CPU 31 is a microprocessor which controls the entire image forming apparatus 1 and is a main part of the system controller. The CPU 31 is connected to the respective portions such as the feeding portion 4, the printer portion 2, the discharging portion 5, and the like, and not only exchanges signals with these portions, but also controls the operation of each of these portions. In the ROM 32, an image formation control sequence for forming the image on the recording material S is stored.

To the controller 3, the charging power source 73, the developing power source 74, the primary transfer power source 75, the secondary transfer power source 76, and a potential regulating power source 80 described hereinafter, which are controlled by signals from the controller 3, respectively, are connected. Incidentally, although omitted from illustration, in this embodiment, each of the charging power source 73, the developing power source 74, and the primary transfer power source 75, is provided independently from the associated image forming unit 10. Further, in this embodiment, the potential regulating power source 80 is made common to the potential regulating members 8 (described later) provided for the four primary transfer portions N1. In addition, to the controller 3, the temperature sensor 71 and the humidity sensor 72 are connected. In addition, to the controller 3, the voltage detecting sensor 75a and the current detecting sensor 75b of the primary transfer power source 75, the voltage detecting sensor 76a and the current detecting sensor 76b of the secondary transfer power source 76, and a voltage detecting sensor 80a and a current detecting sensor 80b of the potential regulating member 80 described later are connected. In addition, to the controller 3, the fixing temperature sensor 77, or the like is connected. A signal (information) indicating a detection result of each of the sensors is inputted to the controller 3.

Further, to the controller 3, an operating portion 70 is connected. The operating portion 70 includes an input portion constituted by an operation button (key) or the like as an input means, and a display portion 70a constituted by a liquid crystal panel (display) or the like as display means. Incidentally, in this embodiment, the display portion 70a is constituted as a touch panel, and also has a function as the input means. An operator such as a user or a service person operates the operating portion 70 and thus is capable of causing the image forming apparatus 1 to execute a job (described later). The controller 3 receives the signal from the operating portion 70 and operates various devices of the image forming apparatus 1. Further, the image forming apparatus 1 can also execute the job depending on the signal, for example, from the external device such as the personal computer, not from the operating portion 70.

Here, the image forming apparatus 1 executes a job (printing job), which is a series of operations, for forming and outputting image(s) on a single recording material S or a plurality of recording materials, which are started by a single start instruction. The job includes, in general, an image forming step, a pre-rotation step, a sheet (paper) interval step in the case where images are formed on the plurality of recording materials S, and a post-rotation step. The image forming step is a period in which for an image forming region where an image to be transferred onto the photosensitive drum 11 or the recording material S on the intermediary transfer belt 6 is capable of being formed, formation of the electrostatic image, toner image formation, primary transfer of the toner image, and secondary transfer of the toner image are performed. During image formation (image forming period) refers to this period. Specifically, at positions where steps of the formation of the electrostatic image, the toner image formation, the primary transfer of the toner image, and the secondary transfer of the toner image are performed, timings during the image formation are different from each other. The pre-rotation step is a period, from input of the start instruction until the formation (exposure) of the image to be transferred onto the recording material S is started, in which a preparatory operation before the image forming step is performed. The sheet interval step (recording material interval step, image interval step) is a period corresponding to an interval between a recording material S and a subsequent recording material S when images are successively formed on the plurality of recording materials S (continuous printing, continuous image formation). The post-rotation step is a period in which a post operation (preparatory operation) after the image forming step is performed. During non-image formation (non-image formation period) is a period other than during the image formation and includes the pre-rotation step, the sheet interval step, and the post-rotation step which are described above, and in addition, includes a pre-multi-rotation step which is a preparatory operation during power (switch)-on of the image forming apparatus 1 or during restoration from a sleep state.

### 3. Problem of secondary transfer property

Next, the problem in secondary transfer property will be further described. Incidentally, for convenience, unless otherwise mentioned, a magnitude (high/low) of a voltage and a potential refers to a magnitude (high/low) in the case where values thereof are compared with each other in terms of an absolute value. Further, as regards arrangements of the primary transfer portion N1, the photosensitive drum 11, the primary transfer roller 15, and the potential regulating member 8 described hereinafter, and the like, unless otherwise mentioned, upstream and downstream refer to upstream and downstream with respect to the conveying direction (process progression direction, movement direction) of the intermediary transfer belt 6.

As described above, the toner on the intermediary transfer belt 6 has a tendency that the charge amount thereof is increased by being subjected to the electric discharge between the intermediary transfer belt 6 and the photosensitive drum 11 on the side downstream of the primary transfer portion N1. When the present inventors proceeded with study, it turned out that a mirror force between the toner and intermediary transfer belt 6 increased by the increase in charge amount of the toner on the intermediary transfer belt 6 and thus it became difficult to transfer the toner onto the recording material S in the secondary transfer portion N2. For example, when the charge amount of the toner on the intermediary transfer belt 6 is increased, a secondary transfer electric field necessary to transfer the toner onto the recording material in the secondary transfer portion N2 becomes large, so that graininess of the image becomes worse in some cases. Further, for example, it is difficult to uniformly transfer the toner onto the embossed paper with surface unevenness or the like due to that a gap is formed between the intermediary transfer belt 6 and the paper in the secondary transfer portion N2 and a relatively large secondary transfer electric field is required or the like. For that reason, when the charge amount of the toner on the intermediary transfer belt 6 is increased, it becomes further difficult to uniformly transfer the toner on the embossed paper with surface unevenness, or the like. Incidentally, the embossed paper is paper (fancy paper) provided with an uneven pattern by using a method such as embossing or stamping on the surface of the paper. Further, also as regards a recording material relatively high in electric resistance (high-resistance paper) such as synthetic paper principally comprising synthetic resin or a resin film, similarly as the above-described embossed paper it becomes further difficult to transfer the toner when the charge amount of the toner on the intermediary transfer belt 6 is increased.

In order to suppress the increase in charge amount of the toner on the side downstream of the primary transfer portion N1 as described above, suppression of the electric discharge on the side downstream of the primary transfer portion N1 is effective. For that purpose, it is effective that a potential difference between the photosensitive drum 11 and the intermediary transfer belt 6 after the primary transfer is made small. Further, when the present inventors proceeded with study, in order to suppress the electric discharge on the side downstream of the primary transfer portion N1, it turned out that it is effective that a potential regulating member which is an electroconductive electrode member is provided on the side downstream of the primary transfer portion N1 and on an inner peripheral surface (back surface) side of the intermediary transfer belt 6 and that a bias of the same polarity as the charge polarity of the photosensitive drum 11 is applied to this potential regulating member. Particularly, the above-described electric discharge can be more effectively suppressed by disposing the potential regulating member 8 in contact with the inner peripheral surface of the intermediary transfer belt 6 and by applying the voltage of the same polarity as the charge polarity of the photosensitive drum 11 to the potential regulating member 8.

Further, the above-described electric discharge occurs in a range of about 0.3 to 1.5 mm from the primary transfer portion N1 toward a downstream side in many cases. On the other hand, it would be considered that by applying the voltage of the same polarity as the charge polarity of the photosensitive drum 11 to the potential regulating member 8, the above-described electric discharge can be suppressed by the action of an electric field formed in a space between the photosensitive drum 11 and the potential regulating member 8. Further, the above-described electric discharge suppressing effect is larger in the case where the potential regulating member 8 is surface-contacted to the intermediary transfer belt 6 with a width with respect to the feeding direction of the intermediary transfer belt 6 than in the case where the potential regulating member 8 is point (line)-contacted to the intermediary transfer belt 6 with respect to the feeding direction of the intermediary transfer belt 6. Further, by bringing the potential regulating member 8 into surface contact with the intermediary transfer belt 6, a contact state between the intermediary transfer belt 6 and the potential regulating member 8 can be stabilized. This would be considered that an electrostatic adsorption force acts between the intermediary transfer belt 6 and the potential regulating member 8.

Thus, it is more preferable that the potential regulating member 8 is surface-contacted to the intermediary transfer belt 6.

Here, the surface contact (contact at the surface) means that the contact does not include the case where the potential regulating member 6 is contacted to the intermediary transfer belt 6 only in a line shape with respect to a direction crossing the feeding direction of the intermediary transfer belt 6 in a range narrower than a contact width (about 5 to 50 mm) as described specifically hereinafter. Accordingly, the surface contact (contact at the surface) includes, for example, not only the case where a substantially entire region of the potential regulating member 8 is continuously and closely contacted to the intermediary transfer belt 6 in a region of the contact width described specifically hereinafter but also that many contact points are substantially uniformly distributed in the above-described range as in the case of a nonwoven fabric or the like.

### 4. Potential regulating member

Next, a constitution of the potential regulating member 8 in this embodiment will be described. As shown in FIG. 1, in the image forming apparatus 1 of this embodiment, on sides downstream of the primary transfer portions N1y, N1m, N1c, and N1k, potential regulating members 8y, 8m, 8c, and 8k which are electrode members are provided, respectively, in contact with the inner peripheral surface of the intermediary transfer belt 6. In this embodiment, the potential regulating members 8y, 8m, 8c, and 8k provided in the primary transfer portions N1y, N1m, N1c, and N1k, respectively, have the substantially same constitution.

A shape of the potential regulating member 8 in this embodiment will be described. Part (a) of FIG. 3 is a sectional view (cross section substantially perpendicular to a rotational axis direction of the photosensitive drum 11) of the potential regulating member 8 in this embodiment. Further, part (b) of FIG. 3 is a perspective view of the potential regulating member 8 in this embodiment.

In this embodiment, the potential regulating member 8 includes a planar first portion 81 provided along a widthwise direction (direction substantially perpendicular to the conveying direction, direction substantially parallel to the rotational axis direction of the photosensitive drum 11) of the intermediary transfer belt 6. Further, in this embodiment, the potential regulating member 8 includes a planar second portion 82 provided along the widthwise direction of the intermediary transfer belt 6 and extending in a direction crossing, in this embodiment, substantially perpendicular to a flat surface of the first portion 81. In this embodiment, a contact surface 83 of the first portion 81 of the potential regulating member 8, which is a contact portion contacting the inner peripheral surface of the intermediary transfer belt 6 is a flat surface. That is, in this embodiment, the first portion 81 constituting the contact surface 83 of the potential regulating member 8 is a flat plate.

Here, in a cross section substantially perpendicular to the rotational axis direction of the photosensitive drum 11, an upstream-side end portion of the contact surface 83 is defined as "A" (or "upstream end A"), and a downstream-side end portion of the contact surface 83 is defined as "B" (or "downstream end B"). In this embodiment, the upstream end A of the contact surface 83 corresponds to an upstream-side end portion of the potential regulating member 8, and the downstream end B of the contact surface 83 corresponds to a downstream-side end portion of the potential regulating member 8. As described above, in order to more effectively suppress the electric discharge between the intermediary transfer belt 6 and the photosensitive drum 11, the potential regulating member 8 may preferably be surface-contacted to the intermediary transfer belt 6. From this viewpoint, a length of a line segment AB (between A and B), i.e., a "contact width" which is a length of the contact surface 83 in the conveying direction of the intermediary transfer belt 6 may preferably be 5 mm or more. With a longer length of the line segment AB, the above-described effect of suppressing the electric field becomes larger, but it would be considered that when the length is made excessively long, stable contact of the potential regulating member 8 with the intermediary transfer belt 6 becomes difficult by the influence of part (component) accuracy or the like. The length of the line segment AB is sufficient in many cases when the length is 50 mm or less, and typically is 30 mm or less. That is, the length of the line segment AB may suitably be about 5 to 50 mm, typically about 5 to 30 mm. From another viewpoint, it can be said that the length of the line segment AB is enough to be not more than a half of a center distance between adjacent photosensitive drums 11 in a cross section substantially perpendicular to the rotational axis direction of the photosensitive drum 11 in many cases. In this embodiment, the potential regulating member 8 which is 25 mm in length of the line segment AB is used. Incidentally, in this embodiment, the center distance between the photosensitive drums 11 in the cross section substantially perpendicular to the rotational axis direction of the photosensitive drum 11 is about 100 mm.

To the potential regulating member 8, the potential regulating power source 80 as a potential regulating bias applying means (potential regulating bias applying portion) is connected. To the potential regulating member 80, the voltage detecting sensor 80a (FIG. 2) as a voltage detecting means (voltage detecting portion) for detecting an output voltage thereof and the current detecting sensor 80b (FIG. 2) as a current detecting means (current detecting portion) for detecting an output current thereof are connected. In this embodiment, to the second portion 82 of the potential regulating member 8, the potential regulating power source 80 is connected. At least at the time of the primary transfer during the image forming operation, to the potential regulating member 8, a potential regulating bias (potential regulating voltage) which is a DC voltage of the same polarity as the charge polarity of the photosensitive drum 11 is applied by the potential regulating power source 80. The time of the primary transfer is specifically a period in which the primary transfer bias is applied, more specifically, a period in which an image forming region (region onto which the toner image is capable of being transferred) on the intermediary transfer belt 6 passes through the primary transfer portion N1. By this, a potential difference between the intermediary transfer belt 6 and the photosensitive drum 11 on the side downstream of the primary transfer portion N1 is made small, so that it is possible to suppress the electric discharge between the intermediary transfer belt 6 and the photosensitive drum 11 on the side downstream of the primary transfer portion N1. In this embodiment, the potential regulating bias is a DC voltage of a negative polarity. In this embodiment, the potential regulating bias is subjected to constant-voltage control. Further, in the constitution of this embodiment, the potential regulating bias (constant voltage of the negative polarity) may preferably be about -500 to -5000, more preferably be about -1000 to -3000 V. Incidentally, in this embodiment, the constant voltage was applied to the potential regulating member 8 by the potential regulating power source 80, but certain effect can be expected even when the potential regulating member 8 is grounded.

The potential regulating member 8 is a member long in the widthwise direction of the intermediary transfer belt 6. A length of the contact surface 83 of the potential regulating member 8 in a longitudinal direction (direction along the widthwise direction of the intermediary transfer belt 6) may preferably be longer than a maximum image width in the widthwise direction of the intermediary transfer belt 6. Incidentally, the maximum image width is a length of an image forming region of a maximum image capable of being formed by the image forming apparatus 1 with respect to the widthwise direction of the intermediary transfer belt 6. In this embodiment, the length of the contact surface 83 of the potential regulating member 8 in the longitudinal direction is longer than the above-described maximum image width and a width in which the primary transfer roller 15 contacts the intermediary transfer belt 6 with respect to the widthwise direction of the intermediary transfer belt 6. That is, in this embodiment, each of a range of the maximum image width and a range in which the primary transfer roller 15 contacts the intermediary transfer belt 6 with respect to the widthwise direction of the intermediary transfer belt 6 falls inside a range of the length of the contact surface 83 of the potential regulating member 8 in the longitudinal direction.

By this, irrespective of a length of the toner image, transferred onto the intermediary transfer belt 6, with respect to the widthwise direction of the intermediary transfer belt 6, it is possible to obtain an effect of suppressing an increase in charge amount of the toner on the intermediary transfer belt 6 by suppressing the above-described electric discharge. On the other hand, in this embodiment, the length of the potential regulating member 8 in the longitudinal direction is shorter than the width of the intermediary transfer belt 6. That is, in this embodiment, the range of the length of the potential regulating member 8 in the longitudinal direction falls inside the range of the width of the intermediary transfer belt 6. By this, it is possible to suppress electric discharge to the potential regulating member 8 and a member around the intermediary transfer belt 8, or the like, capable of occurring in the case where an end portion of the potential regulating member 8 with respect to the longitudinal direction protrudes further than an end portion of the intermediary transfer belt 6 with respect to the widthwise direction does. As a result, a possibility that the effect of suppressing the electrical discharge between the intermediary transfer belt 6 and the photosensitive drum 11 becomes small can be reduced.

The potential regulating member 8 can be constituted only by, for example, a single material having electroconductivity, and as a material constituting the potential regulating member 8, it is possible to use metal, resin, cloth, nonwoven fabric, and the like. In this embodiment, the potential regulating member 8 is constituted substantially only of metal having electroconductivity, such as SUS (stainless steel). Specifically, in this embodiment, the potential regulating member 8 is constituted by forming the first portion 81 and the second portion 82 by subjecting a plate material made of metal (metal plate) such as SUS to bending. By thus subjecting the metal plate to the bending, strength of the potential regulating member 8 can be increased. In this embodiment, each of the first portion 81 and the second portion 82 of the potential regulating member 8 is not substantially deformed in a use state of the image forming apparatus 1. However, the present disclosure is not limited to such an embodiment, but the potential regulating member 8 may also be constituted by two or more materials.

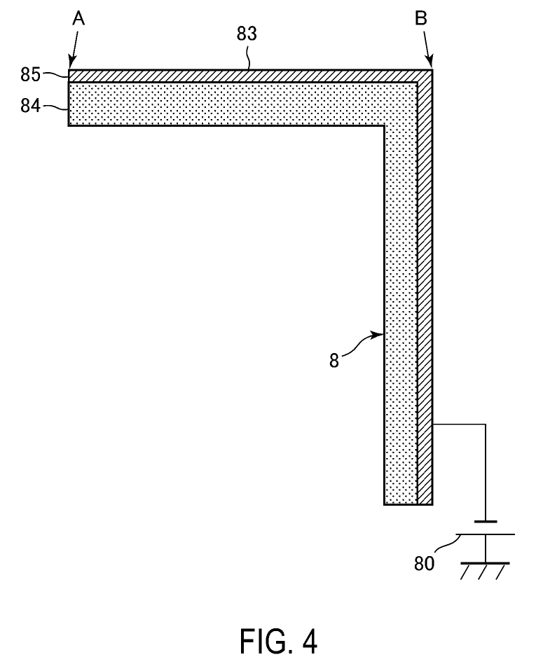

FIG. 4 is a sectional view (showing a cross section substantially perpendicular to the rotational axis direction of the photosensitive drum 11) in another example of the potential regulating member 8. For example, as shown in FIG. 4, a constitution in which a base portion 84 having a shape similar to the shape of the potential regulating member 8 shown in FIG. 3 and a surface layer 85 formed on the base portion 84 are provided can be employed. The surface layer 85 constituting the contact surface 83 contacting the intermediary transfer belt 6 and a connecting portion with the potential regulating power source 80 is formed of an electroconductive material such as metal or an electroconductive resin material. The base portion 84 may be formed of the electroconductive material, but may also be formed of a non-electroconductive material such as a non-electroconductive resin material. The base portion 84 and the surface layer 85 can be fixed by an arbitrary fixing means such as bonding with an adhesive or welding.

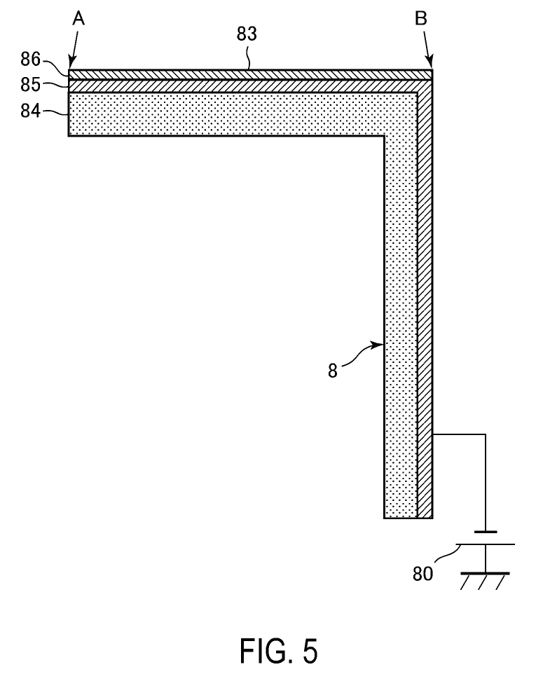

Further, FIG. 5 is a sectional view (showing a cross section substantially perpendicular to the rotational axis direction of the photosensitive drum 11) in still another example of the potential regulating member 8. For example, as shown in FIG. 5, the contact surface 83 of the potential regulating member 8 contacting the intermediary transfer belt 6 may also be formed of an electroconductive nonwoven fabric 86. Incidentally, in FIG. 5, the electroconductive nonwoven fabric 86 is provided on the contact surface 83 of the potential regulating member 8 having the constitution shown in FIG. 4, but may also be provided on the contact surface 83 of the potential regulating member 8 having the constitution shown in FIG. 3. The electroconductive nonwoven fabric 86 can be fixed by an arbitrary fixing means such as bonding with an electroconductive adhesive. Further, instead of the nonwoven fabric 86, for example, materials such as a felt, a pile fabric (cut pile fabric (velvet, brush), and loop pile fabric (toweling)) which are constituted using electroconductive fibers, and a sponge (elastic foam member) constituted using an electroconductive rubber material, and the like may also be used. Thus, the contact surface 83 of the potential regulating member 8 contacting the intermediary transfer belt 6 is constituted by a flexible material or an elastic material, so that it is possible to reduce a possibility of an occurrence of scars on an inner peripheral surface of the intermediary transfer belt 6 caused by friction (slide) between the inner peripheral surface of the intermediary transfer belt 6 and the potential regulating member 8.

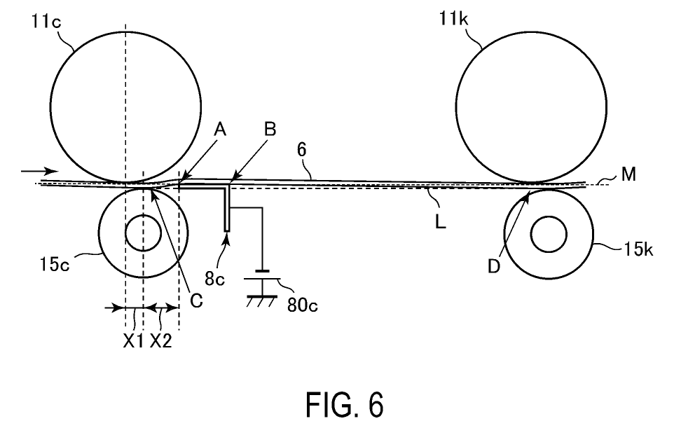

Next, an arrangement of the potential regulating member 8 in this embodiment will be described. FIG. 6 is a sectional view (showing a cross section substantially perpendicular to the rotational axis direction of the photosensitive drum 11) for illustrating the arrangement of the potential regulating member 8 provided between two primary transfer portions N1 adjacent to each other in the conveying direction of the intermediary transfer belt 6. In FIG. 6, as an example, a potential regulating member 8c provided between the primary transfer portions N1c for cyan and N1k for black (i.e., provided for the primary transfer portion N1c for cyan) is shown.

In this embodiment, an outer diameter of the photosensitive drum 11 is 30 mm, an outer diameter of the primary transfer roller 15 is 18 mm, and a thickness of the intermediary transfer belt 6 is 0.350 mm. Further, in this embodiment, the primary transfer roller 15 is offset toward a downstream side relative to the photosensitive drum 11. In this embodiment, an offset amount X1 is 3 mm. Incidentally, the offset amount X1 is a distance between a rotation center of the photosensitive drum 11 and a rotation center of an associated primary transfer roller 15 in a direction along a common tangential line on a side where a plurality of photosensitive drums 11 contact the intermediary transfer belt 6 in a cross section substantially perpendicular to the rotational axis direction of the photosensitive drum 11.

Here, in order to illustrate the arrangement of the potential regulating member 8, the case where the potential regulating member 8 is removed is assumed. In the cross section substantially perpendicular to the rotational axis direction of the photosensitive drum 11, a rectilinear line along which a stretching surface of the intermediary transfer belt on an inner peripheral surface side in a portion downstream of the primary transfer portion N1 passes in the case where there is no potential regulating member 8 is defined as a rectilinear line L. Incidentally, specifically, this rectilinear line L corresponds to the stretching surface in a state in which only the potential regulating member 8 is substantially removed from the constitution of the image forming apparatus 1 (however, the photosensitive drum 11 and the intermediary transfer belt 6 are at rest) in a state during the image forming operation (in a state in which the intermediary transfer belt 6 is in an image formable stretching form). Further, on the rectilinear line L, a portion where the inner peripheral surface of the intermediary transfer belt 6 is separated from a closest stretching member on an upstream side of the potential regulating member 8 is defined as "C" (or "upstream stretching portion C"), and a portion where the inner peripheral surface of the intermediary transfer belt 6 is separated from a closest stretching member on a downstream side of the potential regulating member 8 is defined as "D" (or "downstream stretching portion D"). Incidentally, in FIG. 6, the rectilinear line L is schematically shown substantially horizontally, but in the case where the surface of the primary transfer roller 15 is raised toward the photosensitive drum 11 side by deformation or the like of the elastic layer of the primary transfer roller 15, the rectilinear line L may be inclined downward toward the downstream side in the figure.

In this embodiment, the closest stretching member on the upstream side of the potential regulating member 8 is the primary transfer roller 15, and a position on the inner peripheral surface of the intermediary transfer belt 6 at a portion where the intermediary transfer belt 6 is separated from the primary transfer roller 15 is the upstream stretching portion C. However, the closest stretching member on the upstream side of the potential regulating member 8 is not limited to the primary transfer member 15. For example, in the case where the primary transfer roller 15 is offset toward and disposed on an upstream side relative to the photosensitive drum 11, a position on the inner peripheral surface of the intermediary transfer belt 6 at a portion corresponding to a portion where the intermediary transfer belt 6 is separated from the photosensitive drum 11 is the upstream stretching portion C.

Further, in this embodiment, the closest stretching member on the downstream side of the potential regulating member 8 is one of the photosensitive drums 11m, 11c, and 11k disposed adjacent to the potential regulating member 8 on the downstream side of the potential regulating member 8 for the primary transfer portions N1y, N1m, and N1c, respectively, for yellow, magenta, and cyan. Further, a position on the inner peripheral surface of the intermediary transfer belt 6 at a portion corresponding to a portion where the intermediary transfer belt 6 is separated from an associated one of the photosensitive drums 11m, 11c, and 11k is the downstream stretching portion D. However, the closest stretching member on the downstream side of the potential regulating member 8 is not limited to the photosensitive drum 11. For example, in the case where the primary transfer roller 15 is offset toward and disposed on the upstream side relative to the photosensitive drum 11, a position on the inner peripheral surface of the intermediary transfer belt 6 at a portion where the intermediary transfer belt 6 is separated from the primary transfer roller 15 is the downstream stretching portion D. Further, in this embodiment, for the most downstream primary transfer portion N1k for black, the closest stretching member on the downstream side thereof is the stretching roller (tension roller in this embodiment) 22. Further, a position on the inner peripheral surface of the intermediary transfer belt 6 at a portion where the intermediary transfer belt 6 is separated from the stretching roller 22 is the downstream stretching portion D.

Further, for each of the primary transfer portions N1, as the closest stretching member on the downstream side of the potential regulating member 8, in the case where there is another stretching roller for regulating an attitude of the intermediary transfer belt 6 during the image forming operation, the rectilinear line L and the downstream stretching portion D are defined on the basis of its stretching roller. Further, in the case where not the stretching roller, but a scraper or a brush is contacted to the inner peripheral surface of the intermediary transfer belt 6 for the purpose of cleaning the inner peripheral surface of the intermediary transfer belt 6 or for the like purpose, the scraper or the brush can be regarded as the closest stretching member on the downstream side of the potential regulating member 8 when the scraper or the brush regulates the attitude of the intermediary transfer belt 6 during the image forming operation. The scraper is constituted by a sheet-like or film-like member in general.

As shown in FIG. 6, the potential regulating member 8 is disposed downstream of and close to the primary transfer portion N1 so as not to contact the primary transfer roller 15 and the photosensitive drum 11 via the intermediary transfer belt 6. At this time, as the upstream end A is closer to the primary transfer portion N1, the above-described electric charge suppressing effect between the intermediary transfer belt 6 and the photosensitive drum 11 becomes larger. In this embodiment (FIG. 6), the potential regulating member 8 is disposed in a position downstream of the primary transfer portion N1 so that a distance X2 from the primary transfer roller 15 to the upstream end A becomes about 8 mm. Here, the distance X2 is a distance between the rotation center of the primary transfer roller 15 and the upstream end A in a direction along the common tangential line on a side where the plurality of photosensitive drums 11 contact the intermediary transfer belt 6 in the cross section substantially perpendicular to the rotational axis direction of the photosensitive drum 11. That is, in this embodiment, in the direction along the above-described common tangential line, the distance from the rotation center of the primary transfer roller 15 to the upstream end A is shorter than a distance (radius) from the rotation center of the primary transfer roller 15 to an outer circumference of the primary transfer roller 15. The distance X2 is not limited thereto, but may preferably be about 1 to 20 mm, typically about 1 to 10 mm.

Further, in this embodiment, the potential regulating member 8 is pressed against the inner peripheral surface of the intermediary transfer belt 6 by a pressing spring 87 (part (b) of FIG. 3) constituted by a compression coil spring which is an urging member as an urging means at each of opposing end portions thereof with respect to the longitudinal direction thereof. At this time, the contact portion of the potential regulating member 8 contacting the inner peripheral surface of the intermediary transfer belt 6 is caused to enter the photosensitive drum 11 side relative to the rectilinear line L. By this, even in the case where waving or vibration occurs on the intermediary transfer belt 6 during the image forming operation (during traveling of the intermediary transfer belt 6), the potential regulating member 8 can be more stably contacted to the intermediary transfer belt 6. In this embodiment, a pressing force of the pressing spring 87 is set (adjusted) so that each of the upstream end A and the downstream end B of the contact surface 83 which is the contact portion of the potential regulating member 8 with the inner peripheral surface of the intermediary transfer belt 6 is caused to enter the photosensitive drum 11 side relative to the rectilinear line L by about 0.5 mm. Thus, by causing the contact surface 83 of the potential regulating member 8 to enter the photosensitive drum 11 side relative to the rectilinear line L, even in the case where the waving or the vibration occurs on the intermediary transfer belt 6 during the image forming operation (during the traveling of the intermediary transfer belt 6), the potential regulating member 8 can be more stably surface-contacted to the intermediary transfer belt 6. Although the potential regulating member 8 is not limited thereto, an entering amount of the contact surface 83 of the potential regulating member 8 into the rectilinear line L may preferably be about 0.3 to 5 mm, typically about 0.5 to 3 mm. When this entering amount is excessively small, there is a possibility that it becomes difficult for the potential regulating member 8 to be stably contacted to the intermediary transfer belt 6. When the entering amount is excessively large, there is a possibility that stable feeding (conveyance) of the intermediary transfer belt 6 becomes difficult.

Here, in the cross section substantially perpendicular to the rotational axis direction of the photosensitive drum 11, a rectilinear line passing through the upstream end A and the downstream end B of the contact surface 83 is defined as a rectilinear line M. At this time, it is preferable that the rectilinear line M is prevented from crossing a line segment CD of the rectilinear line L. By this, in the case where the contact surface 83 of the potential regulating member 8 is a flat surface, the intermediary transfer belt 6 and the potential regulating member 8 can be surface-contacted to each other more reliably. In the case where the rectilinear line M crosses the line segment CD of the rectilinear line L, there is a possibility that only either one of an end portion of the potential regulating member 8 on the upstream end A side and an end portion of the potential regulating member 8 on the downstream end B side can contact the inner peripheral surface of the intermediary transfer belt 6. In this case, there is a possibility that it becomes difficult to enhance the above-described electric discharge suppressing effect by the surface contact.

Further, in FIG. 6, the potential regulating member 8 is disposed so that the rectilinear line M and the rectilinear line L are substantially parallel to each other, but when the rectilinear line M falls within a range in which the rectilinear line M does not cross the line segment CD of the rectilinear line L, the potential regulating member 8 may be disposed so that the rectilinear line M is inclined relative to the rectilinear line L. For example, the rectilinear line M is inclined relative to the rectilinear line L so that the upstream end A side is closer to the rectilinear line L than the downstream end B side, so that curvature generated on the intermediary transfer belt 6 due to laying of the intermediary transfer belt 6 in the neighborhood of the upstream end A can be made small. Accordingly, this case is advantageous for reduction in possibility of an occurrence of scars on the inner peripheral surface of the intermediary transfer belt 6 due to friction (slide) with the potential regulating member 8.

Incidentally, the contact portion of the potential regulating member 8 with the inner peripheral surface of the intermediary transfer belt 6 is not limited to the flat surface. For example, the potential regulating member 8 is constituted by a curved plate curved in a convexly curved shape toward the photosensitive drum 11 side in the cross section substantially perpendicular to the rotational axis direction of the photosensitive drum 11, and the contact portion of the potential regulating member 8 contacting the inner peripheral surface of the intermediary transfer belt 6 may be convexly curved surface toward the photosensitive drum 11 side. Thus, the contact portion (contact surface) of the potential regulating member 8 contacting the inner peripheral surface of the intermediary transfer belt 6 has the curved shape, so that it is possible to alleviate stress when the potential regulating member 8 slides with the intermediary transfer belt 6. By using a roller-shaped potential regulating member 8, the contact portion of the potential regulating member 8 contacting the inner peripheral surface of the intermediary transfer belt 6 may also have the curved surface.

### 5. Correction control of primary transfer bias for single primary transfer portion

Next, correction control of the primary transfer bias will be described. In this embodiment, for easy understanding of the present disclosure, first, correction control of the primary transfer bias for a single primary transfer portion N1 will be described. Further, an operation of the correction control of the primary transfer bias is similar between the respective primary transfer portions N1y, N1m, N1c, and N1k, and is independently performed for the primary transfer portions, N1y, N1m, N1c, and N1k in a synchronism manner. That is, in this embodiment, it is assumed that the potential regulating power source 80 is independently provided for each of the four potential regulating members 8.

In this embodiment, the image forming apparatus 1 carries out ATVC (Active Transfer Voltage Control) of the primary transfer portion N1. This is because during the image formation, a primary transfer current necessary to primarily transfer the toner image, on the photosensitive drum 11, onto the intermediary transfer belt 6 is caused to flow through the primary transfer portion N1. Hereinafter, the ATVC of the primary transfer portion N1 is also simply referred to as "ATVC".

Part (a) of FIG. 7 is a schematic graph for illustrating the ATVC. In the ATVC, in order to acquire the primary transfer bias during the image formation depending on a total resistance value of the primary transfer portion N1 constituted by the intermediary transfer belt 6 and the primary transfer roller 15, a voltage-current characteristic is acquired using test biases (test voltages, test currents) is acquired. The ATVC is executed by being controlled by the controller 3.

Specifically, during non-image formation in which there is no toner image in the primary transfer portion N1, a predetermined voltage or a predetermined current is supplied as the test bias from the primary transfer power source 75 to the primary transfer roller 15. A setting value of the predetermined voltage or the predetermined current as the test bias is one level or a plurality of levels. In this embodiment, test biases of three levels are supplied to the primary transfer roller 15 while changing the setting value. Further, when the test bias which is the predetermined voltage is supplied to the primary transfer roller 15, a current flowing through the primary transfer roller 15 (primary transfer power source 75) is detected by the current detecting sensor 75b. Or, when the test bias which is the predetermined current is supplied to the primary transfer roller 15, a voltage (output voltage of the primary transfer power source 75) applied to the primary transfer roller 15 is detected by the voltage detecting sensor 75b. By this, a voltage-current characteristic depending on impedance (total resistance value) of the primary transfer portion N2 can be acquired. On the basis of this voltage-current characteristic, a voltage necessary to flow a primary transfer current suitable for primary transfer of the toner depending on the impedance (total resistance value) of the primary transfer portion N1 can be calculated. Then, during the image formation, the primary transfer bias (herein, referred also to as an "execution bias") is applied to the primary transfer roller 15 under constant-voltage control in which the calculated voltage is used as a target voltage.

In this embodiment, as regards a target current necessary for the primary transfer of the toner, an appropriate value depending on, for example, an environment (temperature, humidity) is acquired in advance in an experiment or the like, and is stored in the ROM 32. In the ATVC, for example, as a first test bias, first, a current corresponding to the target current depending on an environment at that time (for example, 50 μA) is applied to the primary transfer roller 15 under constant-current control ((1) in part (a) of FIG. 7). Then, a value of a voltage applied to the primary transfer roller 15 (for example, 1200 V) when the first test bias is applied to the primary transfer roller 15 is detected. Further, in the ATVC, second and third test biases which are test biases of two levels obtained by decreasing and increasing the voltage value, detected when the first test bias is applied to the primary transfer roller 15, by 200 V are supplied to the primary transfer roller 15 under constant voltage control ((2) and (3) in part (a) of FIG. 7). Then, values of currents flowing through the primary transfer roller 15 when the second and third test biases are applied to the primary transfer roller 15 are detected. From the above-detected three points, a voltage-current characteristic is acquired. Then, on the basis of the acquired voltage-current characteristic, a voltage value necessary to flow the target current is calculated by linear approximation, for example. Incidentally, depending on the constitution of the image forming apparatus 1 or the like, the voltage value necessary to flow the target current may also be acquired by curve approximation. Then, the calculated voltage value is determined as a target voltage of an execution bias Vtr applied during the image formation. During the image formation, the execution bias Vtr is applied to the primary transfer roller 15 under constant-voltage control in which the calculated voltage value is determined as the target voltage.

Incidentally, the constant-current control is control such that output of the power source is adjusted so that a current supplied to a supply object becomes substantially constant at the target current. Further, the constant-voltage control is control such that output of the power source is adjusted so that a voltage applied to an application object becomes substantially constant at a target voltage.

Further, in this embodiment, the ATVC is executed, as during the non-image formation, in the pre-rotation step (or in the post-rotation step) of the toner. However, the present disclosure is not limited thereto, but the ATVC can be executed, for example, in the paper interval step at a predetermined frequency (every predetermined number of sheets subjected to image formation) during the continuous image formation if the execution timing is during the non-image formation.

Here, in this embodiment, the potential regulating bias applied to the potential regulating member 8 is subjected to the constant-voltage control. In this embodiment, as regards the target voltage of the potential regulating bias, an appropriate value depending on, for example, an environment (temperature, humidity) is acquired on the basis of an experiment or the like in advance, and is stored in the ROM 32. During the image formation (or during the ATVC described later), the potential regulating bias is subjected to the constant-voltage control with a target voltage depending on the environment. (That is, the voltage-current characteristic of the primary transfer portion N1 acquired in this embodiment is acquired in a state in which the potential regulating bias is applied to the potential regulating member 8. The potential regulating bias at this time is set to the same value as the potential regulating bias applied during the image formation.) Specifically, the potential regulating bias is set so that an effect of suppressing an increase in charge amount of the toner on the intermediary transfer belt 6, changed depending on the electric discharge on the side downstream of the primary transfer portion N1, becomes sufficiently high. In addition, the potential regulating bias is set so as to be capable of maintaining a sufficient primary transfer property so that primary transfer efficiency does not become a target value or less due to a current flowing from the primary transfer portion N1 to the potential regulating member 8 or a potential difference between the primary transfer bias and the potential regulating bias. That is, a setting value of the potential regulating bias satisfying such a condition is determined in advance by an experiment or the like.

However, by the influence of temperature/humidity environment in which the image forming apparatus 1 is installed, an increase in temperature of the image forming apparatus 1 due to continuous operation of the image forming apparatus 1, or the like, resistance values of the intermediary transfer belt 6, the primary transfer roller 15, and the like are fluctuated.

By this, the primary transfer bias and the potential regulating bias are deviated from a relationship of the current or the voltage, set as a target value, so that there is a case where the primary transfer property is impaired.

By the influence or the like of an individual difference in resistance value of each of the intermediary transfer belt 6, the primary transfer roller 15, and the potential regulating member 8, a degree of the above-described deviation of the current or the voltage changes for each individual of the image forming apparatus 1 or for each use status of the image forming apparatus 1 in some instances.

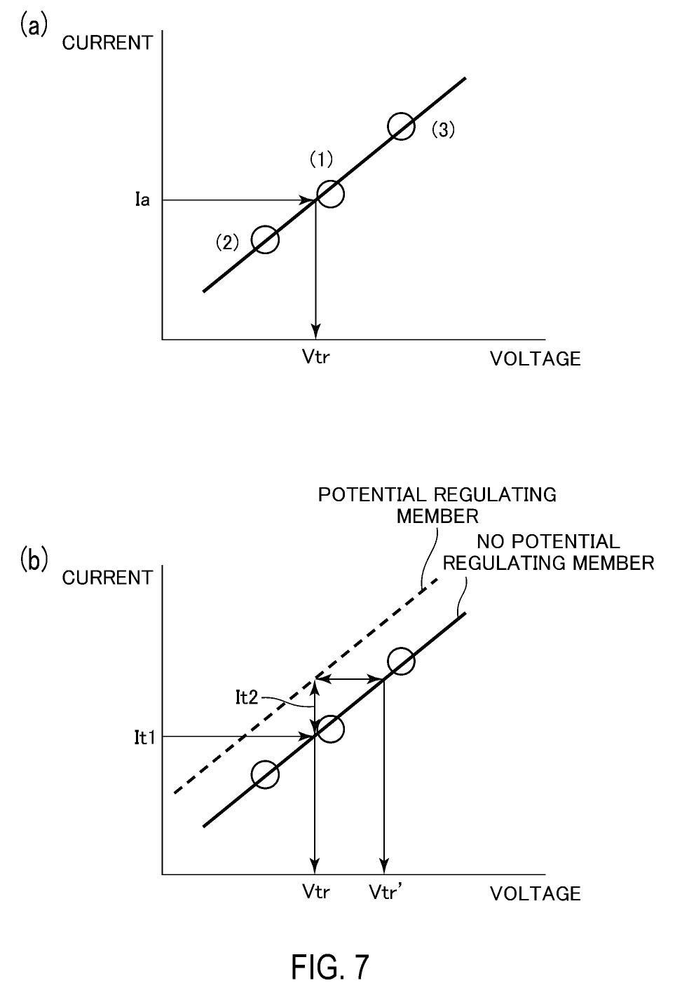

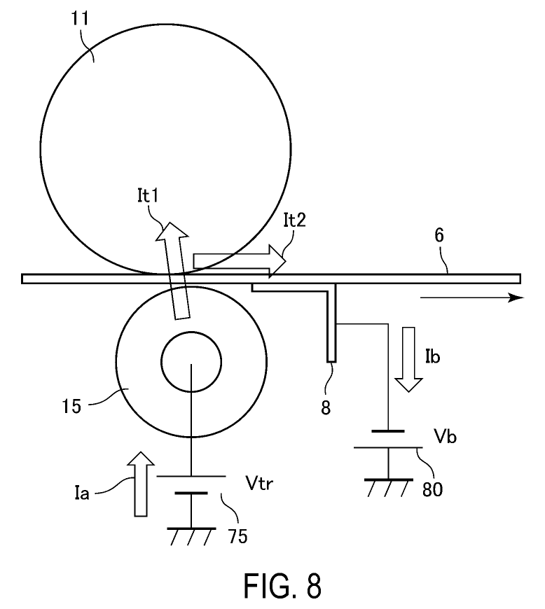

FIG. 8 is a schematic view showing currents around the primary transfer portion N1. For example, when a target current Ia is supplied from the primary transfer power source 75 to the primary transfer roller 15, in the case where the potential regulating member 8 is not provided, the target current Ia and an effective transfer current It1 flowing in the photosensitive drum It1 direction substantially coincide with each other. However, by disposing the potential regulating member 8 downstream of the primary transfer portion N1, a current path from the primary transfer roller 15 is branched to the effective transfer current It1 and an advection current It2 flowing in the potential regulating member 8 direction. As described above, in the ATVC, a target voltage of an execution bias Vtr for causing a target current depending on a total resistance value of the primary transfer portion N1 to flow is determined. At this time, the advection current It2 toward the potential regulating member 8 is fluctuated by the influence of the above-described resistance fluctuation or the like. For that reason, in the case where the ATVC is carried out without considering this advection current It2 toward the potential regulating member 8, or a current Ib detected by the current detecting sensor 80b of the potential regulating power source 80, an actual effective transfer current It1 decreases, so that a primary transfer property is impaired in some instances.

Further, as described above, in order to suppress the electric discharge on the side downstream of the primary transfer portion N1, it is effective that the potential regulating member 8 which is the electroconductive electrode member is disposed on the side downstream of the primary transfer portion N1 and on the inner peripheral surface side of the intermediary transfer belt 6 and then the bias of the same polarity as the charge polarity of the photosensitive drum 11 is applied to the potential regulating member 8. By this, the potential difference between the photosensitive drum 11 and the intermediary transfer belt 6 after the primary transfer is made small, so that it is possible to suppress the electric discharge on the side downstream of the primary transfer portion N1. Further, in order to improve the secondary transfer property by effectively suppressing the electric discharge on the side downstream of the primary transfer portion N1, it is desirable that the potential regulating member 8 is brought near to the primary transfer portion N1 and that the bias, applied to the potential regulating member 8, having the same polarity as that of the photosensitive drum 11 is set high. However, as the potential regulating member 8 is brought nearer to the primary transfer portion N1 and as the bias applied to the potential regulating member 8 is higher, a larger potential difference is created between the primary transfer portion N1 and the potential regulating member 8, so that a leakage current from the primary transfer portion N1 to the potential regulating member 8 becomes higher. For that reason, in the primary transfer portion N1, a primary transfer current flowing in the photosensitive drum 11 direction lowers, so that the primary transfer property is impaired. On the other hand, in order to maintain the primary transfer property, the more the potential regulating member 8 is spaced away from the primary transfer portion N1 and the more the bias applied to the potential regulating member 8 is lowered, the effect of suppressing the electric discharge on the side downstream of the primary transfer portion N1 becomes lower, so that it becomes difficult to suppress the increase in charge amount of the toner and there is a possibility that the secondary transfer property is impaired. Accordingly, in order to improve the secondary transfer property while maintaining the primary transfer property, it is desirable that the primary transfer bias is corrected by taking the current flowing from the primary transfer portion N1 toward the potential regulating member 8 into consideration, and thus the primary transfer current flowing in the photosensitive drum 11 direction can be maintained.

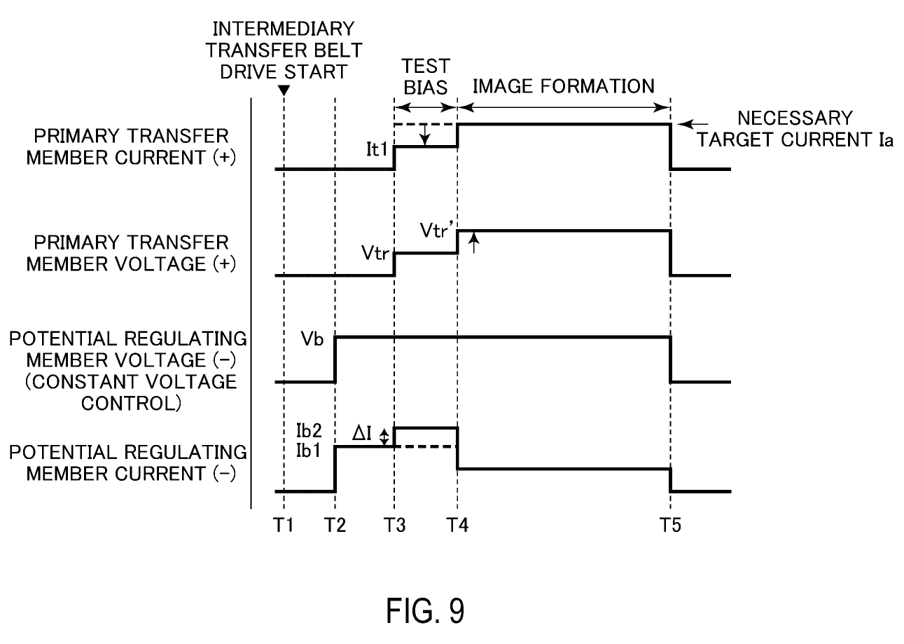

Using FIG. 9 correction control of the primary transfer bias for the single primary transfer portion N1 will be described. FIG. 9 is a timing chart showing progression of voltage values and a current value of the primary transfer bias and the potential regulating bias during execution of the job.

The controller 3 roughly makes correction of the primary transfer bias in the following manner when the ATVC control of the primary transfer portion N1 is executed in the pre-rotation step of the job. In the pre-rotation step of the job, in a state in which the potential regulating bias is applied to the potential regulating member 8, the controller 3 detects the current value of the current flowing through the potential regulating member 8 (potential regulating power source 80) when a test bias is not applied to the primary transfer roller 15 and when the test bias is applied to the primary transfer roller 15. Then, the controller 3 makes correction of the primary transfer bias on the basis of these detected current values. In the following, description will be made more specifically with reference to FIG. 9.

When the job is started, drive of the intermediary transfer belt 6 is started, so that the pre-rotation step is started (T1). Thereafter, application of the potential regulating bias from the potential regulation power source 80 to the potential regulating member 8 under constant-voltage control is started (T2). For example, a target voltage Vb of the potential regulating bias at this time is set to a predetermined voltage X (for example, Vb = -3000V) depending on the environment similar to that during the image formation. Then, before the test bias is applied to the primary transfer roller 15, a current value Ib1 flowing through the potential regulating member 8 (potential regulating power source 80) is detected by the current detecting sensor 80b (for example, Ib1 = -5 μA).

Thereafter, the ATVC is started, and application of the test bias (the above-described first test bias) from the primary transfer power source 75 to the primary transfer roller 15 under the constant-current control is made in order to realize the target current It1 (for example, It1 = 50 μA) (T3). The target current It1 at this time corresponds to a target current of the primary transfer bias depending on the environment during the image formation. Then, as described above, the execution bias Vtr (for example, Vtr = 1200 V) before the correction is determined. Incidentally, as described above, in the ATVC, application of test biases of three levels to the primary transfer roller 15 is made, but in FIG. 9, for simplification, only the test bias aiming at the target current under the constant-current control is shown. Although the execution bias Vtr is stated by the application of the above-described test bias, the execution bias Vtr determined in this case is influenced by a fluctuation in current Ib1 flowing through the potential regulating member 8 (potential regulating power source 80), due to the resistance fluctuation of the intermediary transfer belt 6 as described above. By this, there is a possibility of deviation between the target current Ia and an actual effective transfer current It1.

For that reason, in this embodiment, a current value Ib2 of the current flowing through the potential regulating member 8 (potential regulating power source 80) when the test bias (the above-described first test bias) is applied to the primary transfer roller 15 is detected by the current detecting sensor 80b (for example, Ib2 = -10 μ). Further, a difference Δ1 (= |Ib1-Ib2|) (for example, Δ1 ) 5 μA) between the current value Ib1 detected when the test bias is not applied to the primary transfer roller 15 and the current value Ib2 detected when the test bias is applied to the primary transfer roller 15 is acquired. Then, this difference ΔI is regarded as the advection current It2, and this difference Δ1 is added to the target current It1 of the test bias, so that the target current Ia is determined. Further, on the basis of a voltage-current characteristic acquired by the ATVC, an execution bias Vtr' corrected correspondingly to the target current Ia is determined. Part (a) of FIG. 7 is a schematic graph for illustrating the correction of the primary transfer bias. That is, on the basis of a voltage-current characteristic in the case where the potential regulating member 8 is not provided (the case where the potential regulating bias is OFF) indicated by a solid line in part (b) of FIG. 7, the execution bias Vtr' depending on a voltage-current characteristic in the case where the potential regulating member 8 is provided (the case where the potential regulating bias is ON) indicated by a broken line in part (b) of FIG. 7) can be determined. During the image formation, the determined execution bias Vtr' after the correction is applied to the primary transfer roller 15 under the constant-voltage control (T4 to T5).

Incidentally, in this embodiment, the primary transfer bias is subjected to the constant-voltage control, and therefore, in the above-described correction control of the primary transfer bias, the voltage value corresponding to the target current Ia is determined, but the present disclosure is not limited thereto. For example, in the case where the primary transfer bias is subjected to the constant-current control, it is only required that the target current Ia is determined as described above and during the image formation, the primary transfer bias is subjected to the constant-current control at the determined target current Ia. Also, by this, it becomes possible to make the correction of the primary transfer bias by taking the fluctuation in current flowing through the potential regulating member 8 into consideration. The same applies to the control of this embodiment and control of an embodiment 2 which are described later. In the case where the primary transfer bias is subjected to the constant-current control, by the ATVC, for example, an initial voltage value of the primary transfer bias during the image formation can be determined. Further, the image forming apparatus 1 may also be considered so as to carry out both the constant-voltage control and the constant-current control of the primary transfer bias.

Further, in the above-described correction control of the primary transfer bias, as the current flowing through the potential regulating member 8 (potential regulating power source 80) when the test bias is applied, a current when the above-described first test bias is applied is detected, but the present disclosure is not limited thereto. For example, the execution bias Vtr (before correction) which is determined on the basis of the voltage-current characteristic acquired under application of test biases of a plurality of levels and which corresponds to the target current is applied again as the test bias, and a current flowing through the potential regulating member 8 (potential regulating power source 80) at that time may be detected. The same applies to the control of this embodiment described later.

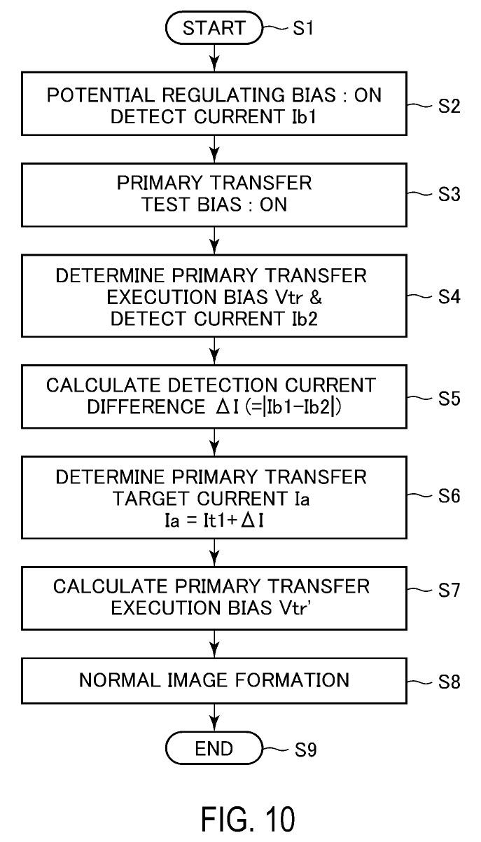

Next, using FIG. 10, a procedure of the correction control of the primary transfer bias for the single primary transfer portion N1 will be described. FIG. 10 is a flow chart showing an outline of a procedure of the job.

When the job is started (S1), the controller 3 causes the potential regulating power source 80 to apply a predetermined voltage to the potential regulating member 8 under the constant-voltage control, and causes the current detecting sensor 80b to detect the current value Ib1 of the current flowing through the potential regulating member 8 (potential regulating power source 80) (S2). Next, the controller 3 causes the primary transfer power source 75 to apply the test biases to the primary transfer roller 15 (S3), and determines the execution bias Vtr before the correction on the basis of the acquired voltage-current characteristic of the primary transfer portion N1 (S4). Further, in S4, the controller 3 causes the current detecting sensor 80b to detect the current value Ib2 of the current flowing through the potential regulating member 8 (potential regulating power source 80) when the test biases (test biases subjected to the constant-current control at the target current It1). Then, the controller 3 acquires the difference (current change) ΔI = (|Ib1-Ib2|) between the current value Ib1 and the current value Ib2 (S5). Thereafter, the controller 3 determines the target current Ia obtained by adding ΔI to the above-described target current It1 (S6). Next, the controller 3 determines the execution bias Vtr' (after correction) corresponding to the target current Ia, on the basis of the above-described voltage-current characteristic of the primary transfer portion N1 (S7). Then, the controller 3 executes the image forming operation under application of the execution bias Vtr' (after correction) to the primary transfer roller 15 under the constant-voltage control (S8), and then ends the job (S9).

### 6. Correction control of primary transfer bias for plurality of primary transfer portions

Next, correction control of a primary transfer bias in the case where a potential regulating bias is applied from a common high-voltage power source to a plurality of potential regulating members 8 provided for a plurality of primary transfer portions N1 will be described. A basic operation of the correction control of the primary transfer bias in this embodiment is similar to that of the correction control of the primary transfer bias for the above-described single primary transfer portion N1.

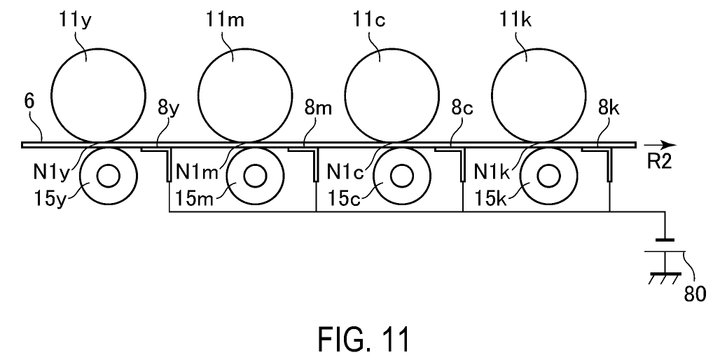

FIG. 11 is a schematic view for illustrating an application constitution of a bias to the plurality of potential regulating members 8 in this embodiment. As shown in FIG. 11, in this embodiment, the potential regulating members 8y, 8m, 8c, and 8k provided for four primary transfer portions N1y, N1m, N2c, and N1k, respectively, are connected in parallel to a single potential regulating power source (high-voltage power source) 80. That is, in this embodiment, the image forming apparatus 1 employs a constitution in which the potential regulating bias is applied from the single potential regulating power source 80 to the four potential regulating members 8y, 8m, 8c, and 8k connected in parallel thereto.

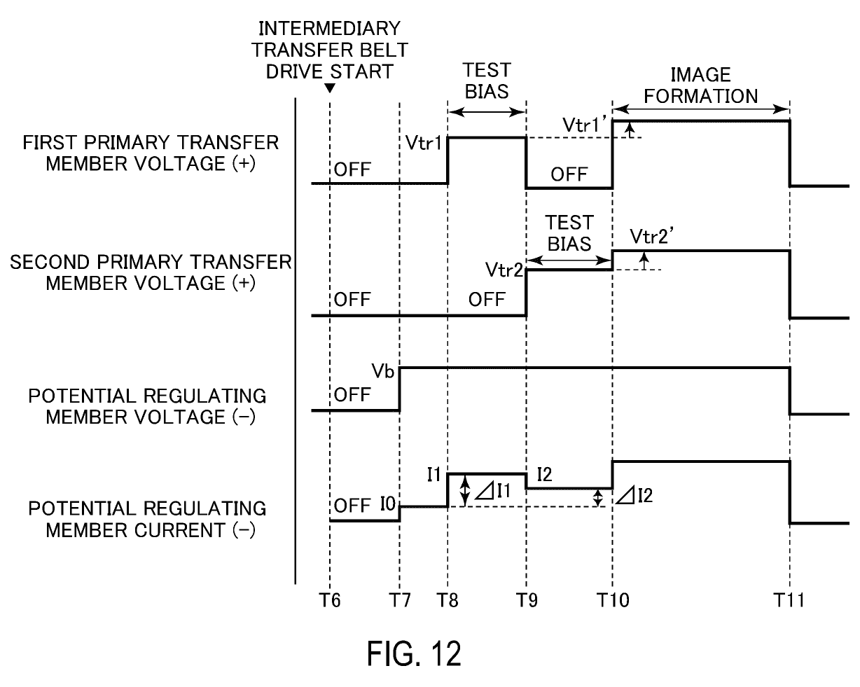

Using FIG. 12, the correction control of the primary transfer bias for the plurality of primary transfer portions N1 in this embodiment will be described. FIG. 12 is a timing chart showing a progression of each of voltage values of primary transfer biases applied to first and second primary transfer members and a progression of each of a voltage value and a current value of a potential regulating bias, during execution of the job in this embodiment. In this case, for simplification, description will be made by paying attention to correction control of the primary transfer biases the first and second primary transfer portions. As an example, the first primary transfer portion is a primary transfer portion N1y for yellow, and the second primary transfer portion is a primary transfer portion N1m for magenta. In addition, the first primary transfer member, a first primary transfer power source, and a first potential regulating member are the primary transfer roller 15y for yellow, the primary transfer power source 75y for yellow, and the potential regulating member 8y for yellow, respectively. In addition, the second primary transfer member, a second primary transfer power source, and a second potential regulating member are the primary transfer roller 15m for magenta, the primary transfer power source 75m for magenta, and the potential regulating member 8m for magenta, respectively.

In this embodiment, when the controller 3 executes the ATVC of the primary transfer portion N1 in the pre-rotation step of the job, the controller 3 roughly makes correction of the primary transfer biases for the first and second primary transfer portions N1y and N1m in the following manner. In the pre-rotation step of the job, the controller 3 causes the power source to apply the potential regulating bias to the plurality of potential regulating members 8 including the first and second potential regulating members 8y and 8m and connected in parallel with each other (hereinafter, these potential regulating members are simply referred to as a "plurality of potential regulating members 8") in a state in which the test biases are not applied to the first and second primary transfer rollers 15y and 15m, and causes the current detecting sensor to detect a current I0 flowing through the plurality of potential regulating members 8 (potential regulating power source 80). Subsequently, the controller 3 causes the power source to successively and individually apply the test biases to the first and second primary transfer rollers 15y and 15m. When the test bias is applied to the first primary transfer roller 15y, the test bias is not applied to the second primary transfer roller 15m. Further, when the test bias is applied to the second primary transfer roller 15m, the test bias is not applied to the first primary transfer roller 15y. In a state in which the test bias is applied to the first primary transfer roller 15y, the controller 3 causes the power source to apply the potential regulating bias to the plurality of potential regulating members 8 and then causes the current detecting sensor to detect a current value I1 flowing through the plurality of potential regulating members 8 (potential regulating power source 80). In addition, in a state in which the test bias is applied to the second primary transfer roller 15m, the controller 3 causes the power source to apply the potential regulating bias to the plurality of potential regulating members 8 and then causes the current detecting sensor to detect a current value I2 flowing through the plurality of potential regulating members 8 (potential regulating power source 80). Then, the controller 3 calculates a difference (current difference) ΔI1 between the current value I0 and the current value I1 and a difference (current difference) ΔI2 between the current value I0 and the current value I2. Further, on the basis of the calculated differences ΔI1 and ΔI2, the controller 3 makes correction of the primary transfer bias for each of the first and second primary transfer rollers 15y and 15m. In the following, description will be made further specifically with reference to FIG. 10.

When the job is started, drive of the intermediary transfer belt 6 is started and the pre-rotation step is started (T6). Thereafter, application of the potential regulating bias from the potential regulating power source 80 to the plurality of potential regulating members 8 under the constant-voltage control is started (T7). In this embodiment, the target value Vb of the potential regulating bias at this time is set to the predetermined voltage (for example, Vb = -3000 V) depending on the environment similar to that during the image formation. Then, before the test bias is applied to the first and second primary transfer rollers 15y and 15m, the current value I0 flowing through the plurality of potential regulating members 8 (potential regulating power source 80) is detected by the current detecting sensor 80b (for example, I0 = -4 μA).

Thereafter, the ATVC is started, and application of the test bias (the above-described first test bias), under the constant-current control, aiming at a target current (for example, 50 μA) from the first primary transfer power source 75y toward the first primary transfer roller 15y performed (T8). The target current at this time corresponds to the target current of the primary transfer bias during the image formation, depending on the environment. Then, similarly as the description about the correction control of the primary transfer bias for the single primary transfer portion N1, an execution bias Vtr1 (before correction) for the first primary transfer portion N1y is determined. Incidentally, similarly as in the case of FIG. 9, in FIG. 12, for simplification, only the test bias, under the constant-current control, aiming at the target current during the image formation is illustrated. At this time, to the second primary transfer roller 15m, the test bias is not applied from the second primary transfer power source 75m. Further, the current value I1 flowing through the plurality of the potential regulating members 8 (potential regulating power source 80) when the test bias is applied to the first primary transfer roller 15y is detected by the current detecting sensor 80b (for example, I1 = -9 μA). Then, a difference ΔI1 (= |I1-ID| (for example, ΔI1 = 5 μA) between the current value I0 detected when the test biases are not applied to the first and second primary transfer rollers 15y and 15m and the current value I1 detected when the test bias is applied to only the first primary transfer roller 15y is acquired.

Subsequently, the test bias applied to the first primary transfer roller 15y is turned off, and application of the test bias (the above-described first test bias), under the constant-current control, aiming at a target current (for example, 50 μA) from the second primary transfer power source 75n toward the second primary transfer roller 15m performed (T9). Then, similarly as the description about the correction control of the primary transfer bias for the single primary transfer portion N1, an execution bias Vtr2 (before correction) for the first primary transfer portion N1m is determined. Further, the current value I2 flowing through the plurality of the potential regulating members 8 (potential regulating power source 80) when the test bias is applied to the second primary transfer roller 15m is detected by the current detecting sensor 80b (for example, I2 = -7 μA). Then, a difference ΔI2 (= |I2-ID| (for example, ΔI2 = 3 μA) between the current value I0 detected when the test biases are not applied to the first and second primary transfer rollers 15y and 15m and the current value I1 detected when the test bias is applied to only the second primary transfer roller 15m is acquired.

Subsequently, similarly as description about the correction control of the primary transfer bias for the single primary transfer portion N1, an execution bias Vtr1' (for example, Vtr1' = 1400 V) corrected for the first primary transfer roller 15y and an execution bias Vtr2' (for example, Vtr2' = 1200 V) corrected for the second primary transfer roller 15m are determined. That is, for example, for the first primary transfer portion N1y, the above-described difference ΔI1 is regarded as the above-described advection current It2, and this current ΔI1 is added to the target current of the above-described test bias, so that the target current Ia is determined. Further, on the basis of the voltage-current characteristic acquired by the ATVC, the execution bias Vtr1' corrected correspondingly to the target current Ia is determined. Also, as regards the second primary transfer portion N1m, the execution bias Vtr2' similarly corrected is determined. During the image formation, the determined execution biases Vtr1' and Vtr2' after the correction are applied to the first and second primary transfer rollers 15y and 15m under the constant-voltage control, respectively (T10 to T11).

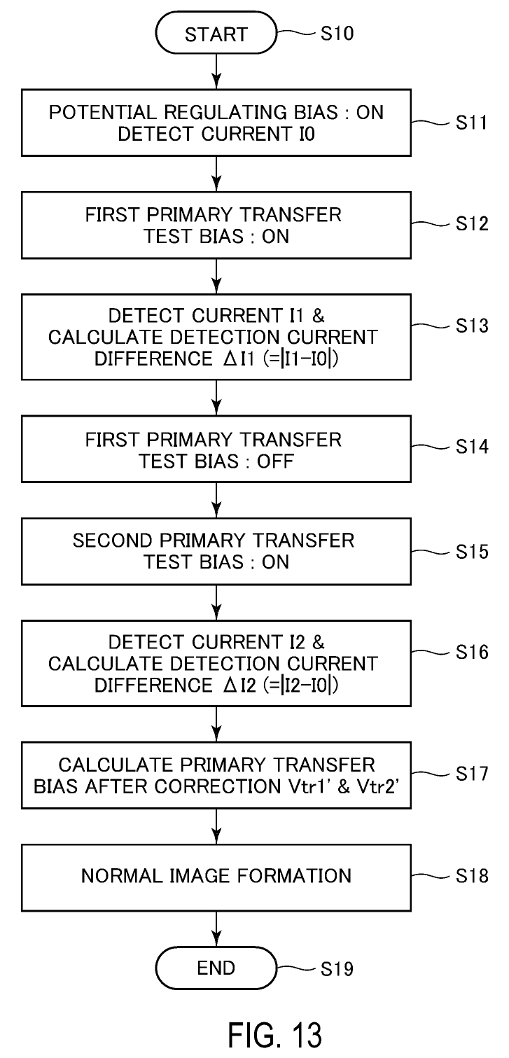

Next, using FIG. 13, a procedure of the correction control of the primary transfer bias for the plurality of primary transfer portions N1 in this embodiment will be described. FIG. 13 is a flowchart showing an outline of a job in this embodiment.

When the job is started (S10), the controller 3 causes the potential regulating power source 80 to start application of a predetermined voltage to the plurality of potential regulating members 8 connected in parallel to the potential regulating power source 80 and causes the current detecting sensor 80b to detect the current value I0 of the current flowing through the plurality of potential regulating members 8 (potential regulating power source 80) (S11). Then, the controller 3 causes the first primary transfer power source 75y to apply the transfer to the first primary transfer roller 15y and determines the execution bias Vtr1 (before correction) to the first primary transfer roller 15y on the basis of the acquired voltage-current characteristic of the first primary transfer portion N1y (S12). Then, the controller 3 causes the current detecting sensor 80b to detect the current value I1 of the current flowing through the plurality of potential regulating members 8 (potential regulating power source 80) when the test bias is applied to the first primary transfer roller 15y, and acquires the difference (current change) ΔI1 (= |I1-I0|) between the current value I0 and the current value I1 (S13). Thereafter, the controller 3 causes the power source to turn off the test bias applied to the first primary transfer roller 15y (S14). Subsequently, the controller 3 causes the second primary transfer power source 75m to apply the test bias to the second primary transfer roller 15m and determines the execution bias Vtr2 (before correction) to the second primary transfer roller 15m on the basis of the acquired voltage-current characteristic of the second primary transfer roller N1m (S15). Then, the controller 3 causes the current detecting sensor 80b to detect the current value I2 of the current flowing through the plurality of potential regulating members 8 (potential regulating power source 80) when the test bias is applied to the second primary transfer roller 15m, and acquires the difference (current change) ΔI2 (= |I2-I0|) between the current value I0 and the current value I2 (S16). Next, similarly as description about the correction control of the primary transfer bias for the single primary transfer portion N1, the controller 3 determines the execution bias Vtr1' after the correction for the first primary transfer roller 15y and the execution bias Vtr2' after correction for the second primary transfer roller 15m (S17). Then, the controller 3 executes a normal image forming operation under application of the execution biases Vtr1' and Vtr2' after correction to the first and second primary transfer rollers 15y and 15m, respectively, under the constant-voltage control (S18), and then ends the job (S19).

In the above, for simplification, the correction control of the primary transfer bias for each of the first and second primary transfer portions was described, but in this embodiment, as shown in FIG. 11, the potential regulating members 8 provided for the four primary transfer portions, respectively, are connected in parallel to the common potential regulating power source 80. In this case, also the correction control of the primary transfer biases to the third and fourth primary transfer portions can be similarly carried out by the above-described method. The same applies to the case where potential regulating member 8 provided for three primary transfer portions, respectively, or for five or more primary transfer portions, respectively, are connected in parallel with the common potential regulating power source 80. That is, similarly as described above for the first and second primary transfer portions, the test bias is applied successively and independently to the plurality of primary transfer portions. Then, similarly as described above, it is possible to correct the primary transfer bias for each of the primary transfer portions on the basis of a difference (current change) between a current value Ix (x = 1, 2, ...) of the current detected when the test bias is applied and the current value I0 detected when the test bias is not applied.

Thus, in this embodiment, the image forming apparatus 1 includes the first photosensitive member (first photosensitive drum) 11y capable of being charged to a predetermined polarity and confirmed to carry a toner image; the second photosensitive member (second photosensitive drum) 11m capable of being charged to the predetermined polarity and confirmed to carry a toner image; the intermediary transfer belt 6 configured to convey the toner image primarily transferred from the first photosensitive member 11y in the first primary transfer portion N1y contacting the first photosensitive member 11y and the toner image primarily transferred from the second photosensitive member 11m in the second transfer portion N1m contacting the second photosensitive member 11m so as to secondarily transfer these toner images onto the recording material S in the secondary transfer portion N2, and capable of being circulated and moved; the first primary transfer member (first primary transfer roller) 15y configured to form the first primary transfer portion N1y in contact with an inner peripheral surface of the intermediary transfer belt 6; the second primary transfer member (second primary transfer roller) 15m configured to form the second primary transfer portion N1m in contact with the inner peripheral surface of the intermediary transfer belt 6; the first electrode member (first potential regulating member) 8y provided on the side downstream of the first primary transfer portion N1yy with respect to a movement direction of the intermediary transfer belt 6 and contacting the inner peripheral surface of the intermediary transfer belt 6; the second electrode member (second potential regulating member) 8m provided on the side downstream of the second primary transfer portion N1m with respect to the movement direction of the intermediary transfer belt 6 and contacting the inner peripheral surface of the intermediary transfer belt 6; the first applying portion (first primary transfer power source) 75y configured to apply the bias of an opposite polarity to the predetermined polarity to the first primary transfer member 15y; the second applying portion (second primary transfer power source) 75m configured to apply the bias of the opposite polarity to the predetermined polarity to the second primary transfer member 15m; the third applying portion (potential regulating power source) 80 configured to apply the bias of the same polarity as the predetermined polarity to the first electrode member 8y and the second electrode member 8m; the detecting portions 80a and 80b (current detecting sensor 80b in this embodiment) configured to detect the current flowing through the third applying portion 80 or the voltage applied to the third applying portion 80; and the controller 3 capable of controlling the first, second and third applying portions 75y, 75m, and 80. In this embodiment, the controller 3 is capable of carrying out control so as to execute the operation in the image forming mode (image forming operation) in which the toner image primarily transferred on the intermediary transfer belt 6 is secondarily transferred onto the recording material S and the operation in the setting mode (correction control of the primary transfer bias in the pre-rotation step) in which the transfer biases (primary transfer biases) applied to the first and second primary transfer members 15y and 15m by the first and second applying portions 75y and 75m in the operation in the image forming mode. Further, in this embodiment, in the operation in the setting mode, the controller 3 acquires a first detection result (I0) by the detecting portion 80b when the biases are not applied to the first and second primary transfer members 15y and 15m by the first and second applying portions 75y and 75m in a state in which the bias is applied to the first and second electrode members 8y and 8m by the third applying portion 80, a second detection result (I1) by the detecting portion 80b when the bias is applied to the first primary transfer member 15y by the first applying portion 75y without applying the bias to the second primary transfer member 15m by the second applying portion 75m in the state in which the bias is applied to the first and second electrode members 8y and 8m by the third applying portion 80, and a third detection result (I2) by the detecting portion 80b when the bias is applied to the second primary transfer member 15m by the second applying portion 75m without applying the bias to the first primary transfer member 15y by the first applying portion 75y in the state in which the bias is applied to the first and second electrode members 8y and 8m by the third applying portion 80, and carries out control so as to set the transfer bias (primary transfer bias), applied to the first primary transfer member 15y, on the basis of the first detection result and the second detection result and so as to set the transfer bias (primary transfer bias), applied to the second primary transfer member 15m, on the basis of the first detection result and the third detection result.

Further, in this embodiment, in the operation in the setting mode, the controller 3 carries out control so as to acquire the first, second and third detection results in a state in which the above-described predetermined bias of the same polarity as the predetermined polarity is applied to the first and second electrode members 8y and 8m under the constant-voltage control by the third applying portion 80. Further, in this embodiment, in the operation in the image forming mode, the controller carries out control so as to apply the above-described predetermined bias to the first and second electrode members 8y and 8m under the constant-voltage control by the third applying portion 80.

Further, in this embodiment, in the operation in the setting mode, the controller 3 carried out control so as to acquire the second detection result after acquiring the first detection result and so as to acquire the third detection result after acquiring the second detection result. Further, in this embodiment, the above-described detecting portion 80b is a third detecting portion 80b. The image forming apparatus 1 includes the first detecting portion (first voltage detecting sensor 75ay, first current detecting sensor 75by) for detecting the current flowing through the first applying portion 75y and the voltage applied to the first applying portion 75y and the second detecting portion (second voltage detecting sensor 75am, second current detecting sensor 75bm for detecting the current flowing through the second applying portion 75m and the voltage applied to the second applying portion 75m. In the operation in the setting mode, the controller 3 carries out control so that the target voltage of the transfer bias applied to the first primary transfer member 15y is set on the basis of the voltage-current characteristic acquired based on the detection between by the first detecting portion 75ay or 75by when the bias is applied to the first primary transfer member 15y by the first applying portion 75y, the preset target current of the transfer bias applied to the first primary transfer member 15y, and the difference between the first detection result and the second detection result and so that the target voltage of the transfer bias applied to the second primary transfer member 15m is set on the basis of the voltage-current characteristic acquired based on the detection result by the second detecting portion 75am or 75bm when the bias is applied to the second primary transfer member 15m by the second applying portion 75m, the preset target current of the transfer bias applied to the second primary transfer member 15m, and the difference between the first detection result and the third detection result. Further, in the operation in the setting mode, the controller 3 may also carry out control so that the target current of the transfer bias applied to the primary transfer member 15y is set on the basis of the preset target current of the transfer bias applied to the first primary transfer member 15y, and the difference between the first detection result and the second detection result and so that the target current of the transfer bias applied to the second primary transfer member 15m is set on the basis of the preset target current of the transfer bias applied to the second primary transfer member 15m, and the difference between the first detection result and the third detection result.

As described above, according to this embodiment, it becomes possible to compatibly realize that the primary transfer property is maintained by ensuring the target current necessary for the primary transfer and that the secondary transfer property is improved by effectively suppressing the electric discharge on the side downstream of the primary transfer portion N1 by the predetermined potential regulating bias. Accordingly, according to this embodiment, in a constitution in which the bias is applied from the common power source to the plurality electrode members provided for the plurality of primary transfer portions, respectively, the secondary transfer property can be improved while maintaining the primary transfer property in each of the primary transfer portions.

### Embodiment 2

Next, another embodiment of the present disclosure will be described. The basic structure and operation of an image forming apparatus of this embodiment are the same as those of the image forming apparatus of the embodiment 1. Accordingly, in the image forming apparatus of this embodiment, elements having the same or corresponding functions or structures as those of the image forming apparatus of the image forming apparatus of the embodiment 1 are denoted by the same reference numerals or symbols as those in the embodiment 1, and detailed description thereof will be omitted.

In this embodiment, another example of the correction control of the primary transfer bias for the plurality of the primary transfer portions will be described. Also, in this embodiment, similarly as in the embodiment 1, for simplification, description will be made by paying attention to the correction control of the primary transfer biases the first and second primary transfer portions. As an example, the first primary transfer portion is the primary transfer portion N1y for yellow, and the second primary transfer portion is the primary transfer portion N1m for magenta.

In the embodiment 1, first, the potential regulating bias was applied to the plurality of the potential regulating members 8 and then the test biases were applied to the first and second primary transfer rollers 15y and 15m, but the present disclosure is not limited to such a constitution. For example, the test biases are applied to the first and second primary transfer rollers 15y and 15m, and then the potential regulating bias may be applied to the plurality of potential regulating members 8. In this case, in a state in which the potential regulating bias is applied to the plurality of potential regulating members 8, test biases are applied successively and individually to the first and second primary transfer rollers 15y and 15m, and a change in current flowing through the first and second primary transfer rollers 15y and 15m is acquired.

Also, by such a method, it becomes possible to apply the primary transfer bias applied to each of the first and second primary transfer portions N1y and N1m.

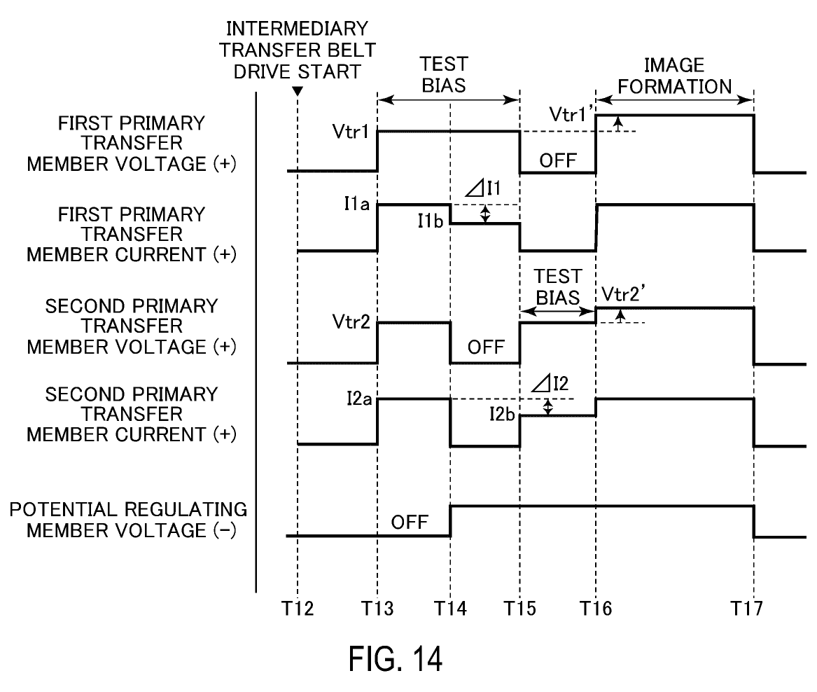

Using FIG. 14, the correction control of the primary transfer bias to the plurality of primary transfer portions N1 in this embodiment will be described. FIG. 14 is a timing chart showing progressions of voltage values and current values of primary transfer biases applied to the first and second primary transfer members and a progression of a voltage value of a potential regulating bias during execution of the job.

When the job is started, drive of the intermediary transfer belt 6 is started, so that the pre-rotation step is started (T12). Thereafter, the ATVC is started before and output voltage from the potential regulating power source 80 is applied to the plurality of potential regulating members 8, and application of the test bias aiming at a target current from the first and second primary transfer power sources 75y and 75m to the first and second primary transfer rollers 15y and 15m, respectively, is performed (T13). Then, the execution biases Vtr1 and Vtr2 before correcting for the first and second primary transfer portions N1y and N1m, respectively, are determined similarly as described in the embodiment 1. Incidentally, in this embodiment, at this time, application of the test bias under the constant-current control or the like is performed, so that the execution biases Vtr1 and Vtr2 are before correction determined. Then, in this embodiment, after the execution biases Vtr1 and Vtr2 before correction are determined, application of the biases (execution biases Vtr1 and Vtr2 before correction) to the first and second primary transfer rollers 15y and 15m in the pre-rotation step is performed under the constant-voltage control. Then, when the execution biases Vtr1 and Vtr2 before correction are applied to the first and second primary transfer rollers 15y and 15m, the current values I1a and I2a of the currents flowing through the first and second primary transfer rollers 15y and 15m (first primary transfer power sources 75y and 75m) are detected by the first and second current detecting sensors 75by and 75bm, respectively. Thereafter, the bias (execution bias Vtr2 before correction) applied to the second primary transfer roller 15m is turned off while maintaining application of the bias (execution bias Vtr1 before correction) applied to the first primary transfer roller 15y, so that application of the potential regulating bias from the potential regulating power source 80 to the plurality of potential regulating members 8 under the constant-voltage control is started (T14). Then, the current value I1b of the current flowing through the first primary transfer roller 15y (first primary transfer power source 75y) is detected by the first current detecting sensor 75by, so that a difference (current changed) ΔI1 (= |I1a-I1b|) between the current value I1a and the current value I1b is acquired.

Next, the bias (execution bias Vtr1) applied to the first primary transfer roller 15y is turned off while maintaining the potential regulating bias to the plurality of potential regulating members 8, and application of the bias (execution bias Vtr2) to the second primary transfer roller 15m is started (resumed) (T15). Then, at that time, the current value I2b of the current flowing through the second primary transfer roller 15m (second primary transfer power source 75m) is detected by the second current detecting sensor 75m, so that a difference (current change) ΔI2 (= |I2a-I2b|) between the current value I2a and the current value I2b is acquired.

Further, similarly as description about the correction control of the primary transfer bias for the single primary transfer portion N1 in the embodiment 1, an execution bias Vtr1' corrected for the first primary transfer roller 15y and an execution bias Vtr2' corrected for the second primary transfer roller 15m are determined. That is, for example, for the first primary transfer portion N1y, the above-described difference ΔI1 is regarded as the above-described advection current It2, and this current ΔI1 is added to the target current of the above-described test bias, so that the target current Ia is determined. Further, on the basis of the voltage-current characteristic acquired by the ATVC, the execution bias Vtr1' corrected correspondingly to the target current Ia is determined. Also, as regards the second primary transfer portion N1m, the execution bias Vtr2' similarly corrected is determined. During the image formation, the determined execution biases Vtr1' and Vtr2' after the correction are applied to the first and second primary transfer rollers 15y and 15m under the constant-voltage control, respectively (T16 to T17).

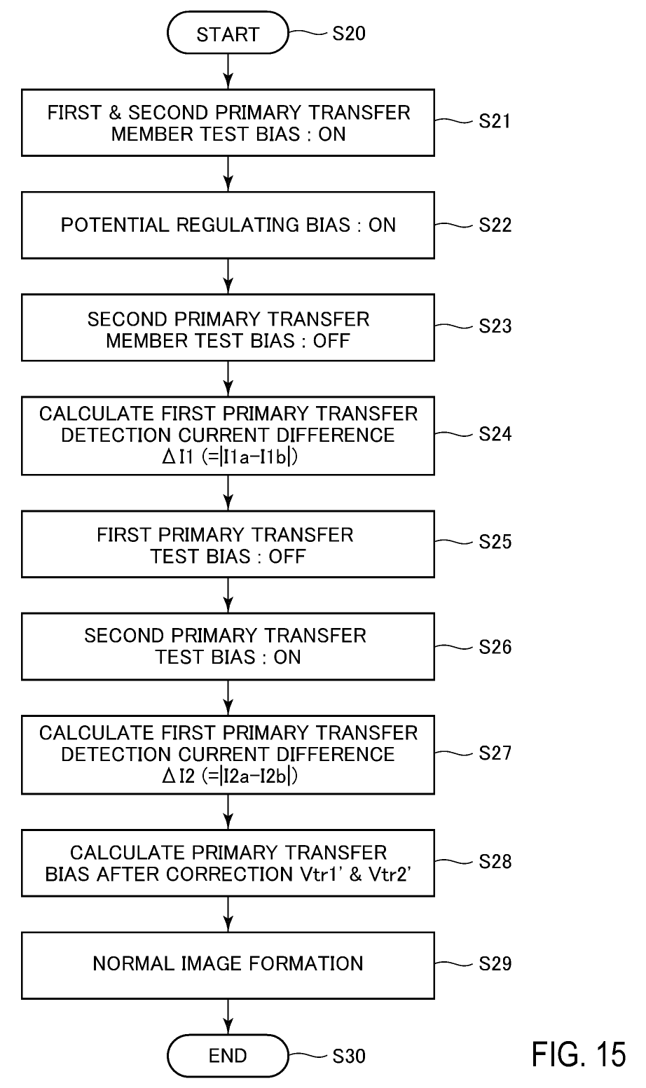

Next, using FIG. 15, a procedure of the correction control of the primary transfer bias for the plurality of primary transfer portions N1 in this embodiment will be described. FIG. 15 is a flowchart showing an outline of a job in this embodiment.

When the job is started (S20), the test biases are applied from the first and second primary transfer power sources 75y and 75m to the first and second primary transfer rollers 15y and 15m, and on the basis of an acquired voltage-control of the first and second primary transfer portions N1y and N1m, execution biases Vtr1 and Vtr2 before correction to the first and second primary transfer rollers 15y and 15m, respectively, are determined (S21). As described above, the controller 3 carried out control so that application of the biases to the first and second primary transfer rollers 15y and 15m in the pre-rotation step is performed under the constant-voltage control after the execution biases Vtr1 and Vtr2 before correction are determined. Further, in S21, the controller 3 causes the current detecting sensors 75by and 75bm to detect the current values I1a and I2a of the currents flowing through the first and second primary transfer rollers 15y and 15m (first and second primary transfer power sources 75y and 75m) when the biases (execution biases Vtr1 and Vtr2 before correction) are applied to the first and second primary transfer rollers 15y and 15m. Thereafter, the controller 3 causes the potential regulating power source 80 to start application of the predetermined voltage to the plurality of potential regulating members 8, connected in parallel with the potential regulating power source 80, under the constant-voltage control while maintaining application of the bias (execution bias Vtr1 before correction) to the first primary transfer roller 15y (S22), and the bias (execution bias Vtr2 before correction) applied to the second primary transfer roller 15m is turned off (S23). Then, the controller 3 causes the first current detecting sensor 75by to detect the current value I1b of the current flowing through the first primary transfer roller 15y (first primary transfer power source 75y), and acquires the difference (current change) ΔI1 (= |I1a-I1b|) between the current value I1a and the current value I1b (S24). Thereafter, the controller 3 causes the power source to turn off the bias (execution bias Vtr1) applied to the first primary transfer roller 15y (S25), and causes the second primary transfer power source 75m to start application (resumption) of the bias (execution bias Vtr2 before correction) to the second primary transfer roller 15m (S26). Then, the controller 3 causes the second current detecting sensor 75bm to detect the current value I2b of the current flowing through the second primary transfer roller 15m (second primary transfer power source 75m), and acquires the difference (current change) ΔI2 (= |I2a-I2b|) between the current value I2a and the current value I2b (S27). Next, similarly as description about the correction control of the primary transfer bias for the single primary transfer portion N1, the controller 3 determines the execution bias Vtr1 after the correction for the first primary transfer roller 15y and the execution bias Vtr2' after correction for the second primary transfer roller 15m (S28). Then, the controller 3 executes a normal image forming operation under application of the execution biases Vtr1' and Vtr2' after correction to the first and second primary transfer rollers 15y and 15m, respectively, under the constant-voltage control (S29), and then ends the job (S30).

In the above, for simplification, the correction control of the primary transfer bias for the first and second primary transfer portions was described, but in this embodiment, as shown in FIG. 11, the potential regulating members 8 provided for the four primary transfer portions, respectively, are connected in parallel to the common potential regulating power source 80. In this case, also the correction control of the primary transfer biases to the third and fourth primary transfer portions can be similarly carried out by the above-described method. The same applies to the case where potential regulating member 8 provided for three primary transfer portions, respectively, or for five or more primary transfer portions, respectively, are connected in parallel with the common potential regulating power source 80. In this case, the primary transfer biases are applied to all the plurality of primary transfer portions in advance and thereafter in a state in which the potential regulating bias is applied to the plurality of potential regulating members, the test biases are applied successively and individually to the plurality of primary transfer portions. Then, similarly as described above, on the basis of the difference (current change) between the currents flowing through the plurality of primary transfer members, it is possible to correct the primary transfer bias for each of the primary transfer portions.

Further, in this embodiment, detection of each of the currents flowing through the first and second primary transfer rollers 15y and 15m (first and second primary transfer power sources 75y and 75m) in a state in which the potential regulating bias is not applied to the plurality of potential regulating members was performed in parallel. However, the present disclosure is not limited to such a constitution, but may also employ, for example, a constitution in which in the state in which the potential regulating bias is not applied to the plurality of potential regulating members 8, the current flowing through the first primary transfer roller 15y and the current flowing through the second primary transfer roller 15m are successively detected. Further, for example, after the detection of the currents flowing through the plurality of the primary transfer rollers 15 in the state in which the potential regulating bias is not applied is finished, the currents flowing through the primary transfer rollers 15 in the state in which the potential regulating bias is not applied can be successively detected.

Incidentally, in this embodiment, primary transfer biases for the first and second primary transfer portions N1y and N1m, respectively, are corrected by acquiring the change in current flowing through the first and second primary transfer rollers 15y and 15m, but the present disclosure is not limited thereto. Instead of the method of acquiring the change in current flowing through the first and second primary transfer rollers 15y and 15m, the change in current flowing through the potential regulating members 8 may be detected by providing a detecting portion for detecting the current flowing through the potential regulating members 8 as in the embodiment 1.

For example, in the state in which the potential regulating bias is not applied to the plurality of potential regulating members 8, each of currents (I1a, I2a) flowing through the potential regulating members is detected when the test biases and applied successively and individually to the first and second primary transfer rollers 15y and 15m.

On the other hand, in the state in which the primary transfer bias is not applied to the plurality of potential regulating members 8, each of currents (I1a', I2a') flow through the potential regulating members 8 is detected when the test biases are applied successively and individually to the first and second primary transfer rollers 15y and 15m.

Further, changes of currents (ΔI1 = I1a-I1a', ΔI2 = I2a-I2a') flowing through the potential regulating members 8 between the case where the potential regulating bias is applied and the case where the potential regulating bias is not applied is acquired. Further, on the basis of the changes of currents (ΔI1 = I1a-I1a', ΔI2 = I2a-I2a') flowing through the potential regulating members 8, the primary transfer bias for each of the first and second primary transfer portions N1y and N1m may be corrected.

Thus, in this embodiment, the image forming apparatus 1 includes the first applying portion (first primary transfer power source) 75y configured to apply the bias of an opposite polarity (charge polarities of the first and second photosensitive members 11y and 11m) to the predetermined polarity to the first primary transfer member 15y; the second applying portion (second primary transfer power source) 75m configured to apply the bias of the opposite polarity to the predetermined polarity to the second primary transfer member 15m; the third applying portion (potential regulating power source) 80 configured to apply the bias of the same polarity as the predetermined polarity to the first electrode member 8y and the second electrode member 8m; the first detecting portions 75ay and 75by (first current detecting sensor 75by in this embodiment) configured to detect the current flowing through the third applying portion 80 or the voltage applied to the first applying portion 75y; the second detecting portions 75am and 75bm (second current detecting sensor 75bm in this embodiment) configured to detect the current flowing through the second applying portion 75y or the voltage applied to the second applying portion 75m; and the controller 3 capable of controlling the first, second and third applying portions 75y, 75m, and 80. In this embodiment, the controller 3 is capable of carrying out control so as to execute the operation in the image forming mode (image forming operation) and the operation in the setting mode (correction control of the primary transfer bias in the pre-rotation step). Further, in this embodiment, in the operation in the setting mode, the controller 3 acquires a first detection result (I1a) by the first detecting portion 75by when the bias is applied to the first primary transfer member 15y by the first applying portion 75y in a state in which the bias is not applied to the first and second electrode members 8y and 8m by the third applying portion 80, a second detection result (I1b) by the second detecting portion 75bm when the bias is applied to the second applying portion 75m in a state in which the bias is not applied to the first and second electrode members 8y and 8m by the third applying portion 80, a third detection result (I1b) by the first detecting portion 75by when the bias is applied to the first primary transfer member 15y by the first applying portion 75y without applying the bias to the second primary transfer member 15m by the second applying portion 75m in the state in which the bias is applied to the first and second electrode members 8y and 8m by the third applying portion 80, and a fourth detection result (I2b) by the second detecting portion 75bm when the bias is applied to the second primary transfer member 15m by the second applying portion 75m without applying the bias to the first primary transfer member 15y by the first applying portion 75y in the state in which the bias is applied to the first and second electrode members 8y and 8m by the third applying portion 80, and carries out control so as to set the transfer bias (primary transfer bias), applied to the first primary transfer member 15y, on the basis of the first detection result and the third detection result and so as to set the transfer bias (primary transfer bias), applied to the second primary transfer member 15m, on the basis of the second detection result and the fourth detection result.

Further, in this embodiment, in the operation in the setting mode, the controller 3 carries out control so as to acquire the third and fourth detection results in a state in which the above-described predetermined bias of the same polarity as the predetermined polarity is applied to the first and second electrode members 8y and 8m under the constant-voltage control by the third applying portion 80. Further, in this embodiment, in the operation in the image forming mode, the controller carries out control so as to apply the above-described predetermined bias to the first and second electrode members 8y and 8m under the constant-voltage control by the third applying portion 80.

Further, in this embodiment, in the operation in the setting mode, the controller 3 carried out control so that when application of the bias to the first primary transfer member 15y by the first detecting portion 75y and application of the bias to the second primary transfer member 15m by the second detecting portion 75m are performed in the state in which the bias is not applied to the first and second electrode members 8y and 8m by the third applying portion 80, the controller 3 acquires the first and second detection results, acquires the third detection result after the first and second detection result are acquired, and acquires the fourth detection result after the third detection result is acquired. In the operation in the setting mode, the controller 3 carries out control so that the target voltage of the transfer bias applied to the first primary transfer member 15y is set on the basis of the voltage-current characteristic acquired based on the detection between by the first detecting portion 75ay or 75by when the bias is applied to the first primary transfer member 15y by the first applying portion 75y, the preset target current of the transfer bias applied to the first primary transfer member 15y, and the difference between the first detection result and the third detection result and so that the target voltage of the transfer bias applied to the second primary transfer member 15m is set on the basis of the voltage-current characteristic acquired based on the detection result by the second detecting portion 75am or 75bm when the bias is applied to the second primary transfer member 15m by the second applying portion 75m, the preset target current of the transfer bias applied to the second primary transfer member 15m, and the difference between the first detection result and the fourth detection result. Further, in the operation in the setting mode, the controller 3 may also carry out control so that the target current of the transfer bias applied to the primary transfer member 15y is set on the basis of the preset target current of the transfer bias applied to the first primary transfer member 15y, and the difference between the first detection result and the third detection result and so that the target current of the transfer bias applied to the second primary transfer member 15m is set on the basis of the preset target current of the transfer bias applied to the second primary transfer member 15m, and the difference between the first detection result and the fourth detection result.

Further, the image forming apparatus 1 may include the detecting portions 80a and 80b (for example, current detecting sensor 80b) for detecting the current flowing through the third applying portion 80 or the voltage applied to the third applying portion 80. Further, in this embodiment, in the operation in the setting mode, the controller 3 acquires a first detection result (I1a) by the detecting portion 80b when the bias is applied to the first primary transfer member 15y by the first applying portion 75y without applying the bias to the second primary transfer member 15m by the second applying portion 75m in a state in which the bias is not applied to the first and second electrode members 8y and 8m by the third applying portion 80, a second detection result (I2a) by the detecting portion 80b when the bias is applied to the second primary transfer member 15m by the second applying portion 75m without applying the bias to the first primary transfer member 15y by the first applying portion 75y in the state in which the bias is not applied to the first and second electrode members 8y and 8m by the third applying portion 80, a third detection result (I1a') by the detecting portion 80b when the bias is applied to the first primary transfer member 15y by the first applying portion 75y without applying the bias to the second primary transfer member 15m by the second applying portion 75m in the state in which the bias is applied to the first and second electrode members 8y and 8m by the third applying portion 80, and a fourth detection result (I2a') by the detecting portion 80b when the bias is applied to the second primary transfer member 15m by the second applying portion 75m without applying the bias to the first primary transfer member 15y by the first applying portion 75y in the state in which the bias is applied to the first and second electrode members 8y and 8m by the third applying portion 80, and may carry out control so as to set the transfer bias, applied to the first primary transfer member 15y, on the basis of the first detection result and the third detection result and so as to set the transfer bias, applied to the second primary transfer member 15m, on the basis of the second detection result and the fourth detection result.

As described above, also by the control in this embodiment, an effect similar to the effect of the embodiment 1 can be obtained.

### Other embodiments

As described above, the present disclosure was described based on specific embodiments, but is not limited to the above-described embodiments.

In the above-described embodiments, the potential regulating member (electrode member) of which contact surface contacting the intermediary transfer belt is the flat surface was the plate-like member formed with the metal plate, but when the potential regulating member is capable of forming a similar contact surface, for example, the potential regulating member may also have another form such as a block-like member having a rectangular cross section. The same applies to a potential regulating member (electrode member) of which contact surface contacting the intermediary transfer belt is a curved surface.

Further, in the above-described embodiments, the predetermined charge polarity of the photosensitive member was the negative polarity, but is not limited thereto. The predetermined charge polarity of the photosensitive member may also be the positive polarity. Similarly, in the above-described embodiments, the normal charge polarity of the toner was the negative polarity, but may also be the positive polarity. Various applied voltages in the case where the predetermined charge polarity of the photosensitive member and the normal charge polarity of the toner are the positive polarity may only be required to be appropriately changed such that these polarities are changed to the polarity opposite to the polarity in the above-described embodiments in accordance with the above-described embodiments.

Further, in the above-described embodiments, the bias applied to the potential regulating member (electrode member) during the image formation was subjected to the constant-voltage control, but may also be subjected to the constant-current control. In this case, the primary transfer bias may also be determined on the basis of the detected voltages in the case where the test biases are applied to the potential regulating members during the ATVC and in the case where the test biases are not applied to the primary transfer members during the ATVC.

Further, the photosensitive member is not limited to a drum-shaped one (photosensitive drum), but may also be an endless belt-like one (photosensitive belt), or the like.

Further, in the above-described embodiments, the image forming apparatus employed the constitution in which the plurality of electrode members provided for the plurality of primary transfer portions, respectively, are connected in parallel with the single high-voltage power source, but the present disclosure is not limited thereto. When the image forming apparatus employs a constitution in which the plurality of electrode members are provided for the plurality of primary transfer portions are connected in parallel with high-voltage power sources in a number smaller than the number of the electrode members, the present disclosure is applicable to correction control of the primary transfer bias for each of the primary transfer portions.

According to this embodiment, in a constitution in which the bias is applied from the common power source to the plurality electrode members provided for the plurality of primary transfer portions, respectively, the secondary transfer property can be improved while maintaining the primary transfer property in each of the primary transfer portions.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-011012 filed on January 25, 2025, which is hereby incorporated by reference herein in its entirety.

What is claimed is:

1. An image forming apparatus comprising:
a first photosensitive member capable of being charged to a predetermined polarity and confirmed to carry a toner image;
a second photosensitive member capable of being charged to the predetermined polarity and confirmed to carry a toner image;
an intermediary transfer belt configured to convey a toner image primarily transferred from the first photosensitive member in a first primary transfer portion contacting the first photosensitive member and a toner image primarily transferred from the second photosensitive member in a second primary transfer portion contacting the second photosensitive member so as to secondarily transfer these toner images onto a recording material in a secondary transfer portion, and capable of being circulated and moved;
a first primary transfer member configured to form the first primary transfer portion in contact with an inner peripheral surface of the intermediary transfer belt;
a second primary transfer member configured to form the second primary transfer portion in contact with the inner peripheral surface of the intermediary transfer belt;
a first electrode member provided on a side downstream of the first primary transfer portion with respect to a movement direction of the intermediary transfer belt and contacting the inner peripheral surface of the intermediary transfer belt;
a second electrode member provided on a side downstream of the second primary transfer portion with respect to the movement direction of the intermediary transfer belt and contacting the inner peripheral surface of the intermediary transfer belt;
a first applying portion configured to apply a bias of an opposite polarity to the predetermined polarity to the first primary transfer member;
a second applying portion configured to apply a bias of the opposite polarity to the predetermined polarity to the second primary transfer member;
a third applying portion as a common power source configured to apply a bias of the same polarity as the predetermined polarity to the first electrode member and the second electrode member;
a first detecting portion configured to detect a current flowing through the first applying portion or a voltage applied to the first applying portion;
a second detecting portion configured to detect a current flowing through the second applying portion or a voltage applied to the second applying portion;
a third detecting portion configured to detect a current flowing through the third applying portion or a voltage applied to the third applying portion; and
a controller configured to be capable of executing an operation in a setting mode during non-image formation in which
the controller sets a transfer bias applied to the first primary transfer member, on the basis of a detection result of the first detecting portion when a first test bias is applied to the first primary transfer member, and
the controller sets a transfer bias applied to the second primary transfer member, on the basis of a detection result of the second detecting portion when a second test bias is applied to the second primary transfer member,
wherein in the operation in the setting mode, the controller sets
(i) the transfer bias applied to the first primary transfer member, on the basis of a first detection result of the third detecting portion when the bias is applied to the first primary transfer member by the first applying portion without applying the bias to the second primary transfer member by the second applying portion, and
(ii) the transfer bias applied to the second primary transfer member, on the basis of a second detection result of the third detecting portion when the bias is applied to the second primary transfer member by the second applying portion without applying the bias to the first primary transfer member by the first applying portion.

2. The image forming apparatus according to claim 1, wherein in the operation in the setting mode, the controller acquires a third detection result of the third detecting portion when the bias is applied to the first and second electrode members by the third applying portion in a state in which the biases are not applied to the first and second primary transfer members by the first and second detecting portions, respectively, and the controller sets
(i) the transfer bias applied to the first primary transfer member, on the basis of the first detection result and the third detection result, and
(ii) the transfer bias applied to the second primary transfer member, on the basis of the second detection result and the third detection result.

3. The image forming apparatus according to claim 2, wherein in the operation in the setting mode, the controller carries out control so as to acquire the first, second, and third detection results in a state in which a predetermined bias of the same polarity as the predetermined polarity is applied under constant-voltage control to the first and second electrode members by the third applying portion.

4. The image forming apparatus according to claim 3, wherein in an operation in an image forming mode in which the toner image primarily transferred on the intermediary transfer belt is secondarily transferred onto the recording material, the controller carried out control so that the predetermined bias is applied under constant-voltage control to the first and second electrode members by the third applying portion.

5. The image forming apparatus according to claim 2, wherein in the operation in the setting mode, the controller carried out control so as to acquire the first detection result after acquiring the third detection result and then to acquire the second detection result after acquiring the first detection result.

6. The image forming apparatus according to claim 2, wherein in the operation in the setting mode, the controller carried out control so as to set
(i) a target voltage of the transfer bias applied to the first primary transfer member, on the basis of a voltage-current characteristic acquired based on the detection result of the first detecting portion when the bias is applied to the first primary transfer member by the first applying portion, a preset target current of the transfer bias applied to the first primary transfer member, and a difference between the first detection result and the third detection result, and
(ii) a target voltage of the transfer bias applied to the second primary transfer member, on the basis of a voltage-current characteristic acquired based on the detection result of the second detecting portion when the bias is applied to the second primary transfer member by the second applying portion, a preset target current of the transfer bias applied to the second primary transfer member, and a difference between the second detection result and third detection result.

7. The image forming apparatus according to claim 2, wherein in the operation in the setting mode, the controller sets
(i) a target current of the transfer bias applied to the first primary transfer member, on the basis of a preset target current of the transfer bias applied to the first primary transfer member and a difference between the first detection result and the third detection result, and
(ii) a target current of the transfer bias applied to the second primary transfer member, on the basis of a preset target current of the transfer bias applied to the second primary transfer member and a difference between the second detection result and the third detection result.

8. An image forming apparatus comprising:
a first photosensitive member capable of being charged to a predetermined polarity and confirmed to carry a toner image;
a second photosensitive member capable of being charged to the predetermined polarity and confirmed to carry a toner image;
an intermediary transfer belt configured to convey a toner image primarily transferred from the first photosensitive member in a first primary transfer portion contacting the first photosensitive member and a toner image primarily transferred from the second photosensitive member in a second primary transfer portion contacting the second photosensitive member so as to secondarily transfer these toner images onto a recording material in a secondary transfer portion, and capable of being circulated and moved;
a first primary transfer member configured to form the first primary transfer portion in contact with an inner peripheral surface of the intermediary transfer belt;
a second primary transfer member configured to form the second primary transfer portion in contact with the inner peripheral surface of the intermediary transfer belt;
a first electrode member provided on a side downstream of the first primary transfer portion with respect to a movement direction of the intermediary transfer belt and contacting the inner peripheral surface of the intermediary transfer belt;
a second electrode member provided on a side downstream of the second primary transfer portion with respect to the movement direction of the intermediary transfer belt and contacting the inner peripheral surface of the intermediary transfer belt;
a first applying portion configured to apply a bias of an opposite polarity to the predetermined polarity to the first primary transfer member;
a second applying portion configured to apply a bias of the opposite polarity to the predetermined polarity to the second primary transfer member;
a third applying portion as a common power source configured to apply a bias of the same polarity as the predetermined polarity to the first electrode member and the second electrode member;
a first detecting portion configured to detect a current flowing through the first applying portion or a voltage applied to the first applying portion;
a second detecting portion configured to detect a current flowing through the second applying portion or a voltage applied to the second applying portion;
a third detecting portion configured to detect a current flowing through the third applying portion or a voltage applied to the third applying portion; and
a controller configured to be capable of executing an operation in a setting mode in which the controller sets a transfer bias applied to the first primary transfer member and a transfer bias applied to the second primary transfer member,
wherein in the operation in the setting mode, the controller sets
(i) the transfer bias applied to the first primary transfer member, on the basis of a first detection result of the first detecting portion when the bias is applied to the first primary transfer member by the first applying portion in a state in which the bias is not applied to the first and second electrode members by the third applying portion, and a second detection result of the first detecting portion when the bias is applied to the first primary transfer member by the first applying portion without applying the bias to the second primary transfer member by the second applying portion in a state in which the bias is applied to the first and second electrode members by the third applying portion, and
(ii) the transfer bias applied to the second primary transfer member, on the basis of a third detection result of the second detecting portion when the bias is applied to the second primary transfer member by the second applying portion in a state in which the bias is not applied to the first and second electrode members by the third applying portion, and a fourth detection result of the second detecting portion when the bias is applied to the second primary transfer member by the second applying portion without applying the bias to the first primary transfer member by the first applying portion in a state in which the bias is applied to the first and second electrode members by the third applying portion.

9. An image forming apparatus comprising:
a first photosensitive member capable of being charged to a predetermined polarity and confirmed to carry a toner image;
a second photosensitive member capable of being charged to the predetermined polarity and confirmed to carry a toner image;
an intermediary transfer belt configured to convey a toner image primarily transferred from the first photosensitive member in a first primary transfer portion contacting the first photosensitive member and a toner image primarily transferred from the second photosensitive member in a second primary transfer portion contacting the second photosensitive member so as to secondarily transfer these toner images onto a recording material in a secondary transfer portion, and capable of being circulated and moved;
a first primary transfer member configured to form the first primary transfer portion in contact with an inner peripheral surface of the intermediary transfer belt;
a second primary transfer member configured to form the second primary transfer portion in contact with the inner peripheral surface of the intermediary transfer belt;
a first electrode member provided on a side downstream of the first primary transfer portion with respect to a movement direction of the intermediary transfer belt and contacting the inner peripheral surface of the intermediary transfer belt;
a second electrode member provided on a side downstream of the second primary transfer portion with respect to the movement direction of the intermediary transfer belt and contacting the inner peripheral surface of the intermediary transfer belt;
a first applying portion configured to apply a bias of an opposite polarity to the predetermined polarity to the first primary transfer member;
a second applying portion configured to apply a bias of the opposite polarity to the predetermined polarity to the second primary transfer member;
a third applying portion as a common power source configured to apply a bias of the same polarity as the predetermined polarity to the first electrode member and the second electrode member;
a first detecting portion configured to detect a current flowing through the first applying portion or a voltage applied to the first applying portion;
a second detecting portion configured to detect a current flowing through the second applying portion or a voltage applied to the second applying portion;
a third detecting portion configured to detect a current flowing through the third applying portion or a voltage applied to the third applying portion; and
a controller configured to be capable of executing an operation in a setting mode during non-image formation in which
the controller sets a transfer bias applied to the first primary transfer member, on the basis of a detection result of the first detecting portion when a first test bias is applied to the first primary transfer member, and
the controller sets a transfer bias applied to the second primary transfer member, on the basis of a detection result of the second detecting portion when a second test bias is applied to the second primary transfer member,
wherein in the operation in the setting mode, the controller sets
(i) the transfer bias applied to the first primary transfer member, on the basis of information on the current flowing through the third applying portion or the voltage applied to the third applying portion when the bias is applied to the first primary transfer member by the first applying portion without applying the bias to the second primary transfer member by the second applying portion, and
(ii) the transfer bias applied to the second primary transfer member, on the basis of information on the current flowing through the third applying portion or the voltage applied to the third applying portion when the bias is applied to the first primary transfer member by the first applying portion without applying the bias to the second primary transfer member by the second applying portion.
